(19) United States
(12) Patent Application Publication
(10) Pub. No.: US 2020/0374113 A1
(43) Pub. Date: Nov. 26, 2020

(54) DECENTRALIZED APPLICATION PLATFORM FOR PRIVATE KEY MANAGEMENT

(71) Applicant: Orbs Ltd., Tel Aviv (IL)

(72) Inventors: Oded NOAM, Tel Aviv (IL); Oded WERTHEIM, Tel Aviv (IL); Tal Shalom KOL, Tel Aviv (IL)

(21) Appl. No.: 16/968,603

(22) PCT Filed: Feb. 11, 2019
(86) PCT No.: PCT/US2019/017502

§ 371 Date: Aug. 10, 2020

Related U.S. Application Data
(60) Provisional application No. 62/628,770, filed on Feb. 9, 2018.
(60) Provisional application No. 62/635,537, filed on Feb. 26, 2018.
(60) Provisional application No. 62/642,164, filed on Mar. 13, 2018.

(51) Int. Cl. H04L 9/08; H04L 9/32; H04L 9/06

(52) U.S. Cl. CPC H04L 9/0847; H04L 9/3271; H04L 9/085; H04L 2209/16; H04L 9/3213; H04L 9/0637; H04L 2209/38; H04L 9/3218

(57) ABSTRACT

Systems and methods are disclosed for decentralized application platforms for private key management. In one implementation, an authentication request associated with a user identifier is received within a first node of a decentralized authentication network. An authentication challenge is generated in accordance with an authentication protocol associated with the user identifier. Proof of possession of an authentication credential is received in response to the authentication challenge. A verification is performed to determine that the received proof conforms to the authentication protocol. Based on a verification that the received proof conforms to the authentication protocol, an authenticated operation is initiated with respect to a share of a cryptographic key stored at the first node and associated with the user identifier. The authenticated operation is completed in conjunction with one or more other shares of the cryptographic key that satisfy a defined cryptographic threshold.

### CROSS-REFERENCE TO RELATED APPLICATIONS

This application is related to and claims the benefit of priority to U.S. Patent Application No. 62/628,770, filed Feb. 9, 2018, U.S. Patent Application No. 62/635,537, filed Feb. 26, 2018, and U.S. Patent Application No. 62/642,164, filed Mar. 13, 2018, each of which is incorporated herein by reference in its respective entirety.

### TECHNICAL FIELD

Aspects and implementations of the present disclosure relate to decentralized data processing and, more specifically, but without limitation, to decentralized application platforms for private key management.

### BACKGROUND

Cryptographic techniques are commonly used to verify the authenticity of identities, authorizations, documents and more.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example system, in accordance with an example embodiment.

FIG. 3 illustrates example scenario(s) described herein, according to example embodiments.

FIG. 4 illustrates example scenario(s) described herein, according to example embodiments.

FIG. 5 illustrates example scenario(s) described herein, according to example embodiments.

FIG. 6 illustrates example scenario(s) described herein, according to example embodiments.

FIG. 7 illustrates example scenario(s) described herein, according to example embodiments.

FIG. 8 illustrates an example system, in accordance with an example embodiment.

FIG. 9 is a flow chart illustrating aspects of a method for decentralized key management, in accordance with an example embodiment.

FIG. 10 is a block diagram illustrating components of a machine able to read instructions from a machine-readable medium and perform any of the methodologies discussed herein, according to an example embodiment

### DETAILED DESCRIPTION

Aspects and implementations of the present disclosure are directed to decentralized application platforms for private key management.

The described technologies enable features including the commoditization of blockchain infrastructure for large scale consumer applications. In certain implementations, a fully decentralized platform is enabled in which various entities (e.g., consumer brands) can operate nodes and take part in a decentralized and balanced ecosystem. Such a platform can include a core product experience that provides capabilities previously only available in centralized infrastructure solutions.

The described decentralized systems include distributed systems where a group of independent nodes operate on local information to accomplish global goals. These systems may lack a central controller that exercises governance, supervision and control over the system, thus allowing power to be distributed over the network in a more uniform and fair manner.

The described consensus can be a shared view of reality that is agreed upon between different parts of a system. For example, consider a consumer application such as an instant messenger application in which users chat amongst themselves. Such a system may need to implement consensus processes, techniques, etc., in order to operate, e.g., to enable each user to authenticate and speak only on their own behalf. It is advantageous for the various members to reach a shared view of reality regarding which user is which, who owns every username, etc.

Whereas decentralized systems are easy to build without consensus and consensus is easy to achieve in centralized systems, maintaining both properties in the same system proves difficult. In the field of decentralized consensus, decentralized systems can enable a group of independent nodes to reach a shared view of reality. Cryptocurrencies are one example of an application that utilizes such a system, where agreement upon the ledger of transactions and balances can be reached without a governing body.

The term blockchain originates from a core implementation construct of cryptocurrencies such as Bitcoin and can refer to a growing list of records (“blocks”) that are linked and secured using cryptography. This chain of blocks can hold the journal of transactions occurring in the network and forms the distributed ledger. The term blockchain can be used synonymously with the core technology providing the infrastructure for such applications.

Tokens are becoming the standard for the transfer of value in the digital world. They are immune to many of the drawbacks fiat currencies face in a digital setting. Tokens can be shared instantaneously across borders, removing the need for separate payment solutions per geography. Businesses can receive tokens directly with minimal integration, cutting out middlemen such as payment providers and the hefty fees they charge. Tokens are easier to secure, reducing fees that are traditionally high to offset chargebacks and fraud. Tokens are also well-suited for flexible payment models such as microtransactions and can be incorporated seamlessly into larger systems through their programmable interfaces.

Tokenization also provides the means to create handcrafted economies and design a controlled environment where consumer apps can monetize effectively. Monetization has always been difficult for consumer apps, many of which must resort to selling the attention and data of their consumers to advertisers and marketers.

A successful token economy can grow to hold billions of dollars of value. Securing so much value on centralized infrastructure is dangerous from both a security and liability perspective. Organizations that are solely responsible for value at this scale are subject to substantial regulation (e.g., banks). This classification inhibits innovation and creates organizations that are centered around compliance and regulation. Decentralized infrastructure provides the means to prevent any single entity from having the power to corrupt such as an ability to embezzle or to manipulate the system for their benefit.

Tokenization also provides the means for consumer apps to distribute the economic value created to multiple stakeholders, particularly to their users. This ensures that users are fairly compensated for the value they create within the app. This model can be particularly advantageous in settings in which monetization may not be in the best interest of the user.

Another benefit of decentralization for consumer apps is the ability to unite or align the interests of multiple entities. The consumer space is slowly consolidating into the hands of a small number of large entities. Decentralization provides the means for the long tail of companies to align together and create combined ecosystems where no single entity can skew the balance of power in its favor. These ecosystems can even carry on after some of the individual entities cease to exist, allowing consumers to have direct ownership of the value they hold, without relying on the services of others.

The described technologies include platforms focused on providing blockchain infrastructure for large scale consumer applications such as messaging applications, etc. Successful consumer entities may have access to millions of end users, e.g., through websites and mobile apps. Many of these consumer entities are well established and have amassed their user base before the blockchain era. The described technologies provide the infrastructure for these entities to build emerging decentralized platforms and other applications for the benefit of their users, such as the ability to tokenize, integrate smart contracts, etc. Bitcoin can be considered the first generation of blockchain technology. Bitcoin utilizes technologies such as the process/implementation of Proof of Work to solve the problem of consensus on a decentralized ledger in a streamlined, elegant and secure way. However, Bitcoin has many inherent limitations, including excessive fees, long confirmation times and difficult upgrade politics. Such drawbacks have prevented Bitcoin from further adoption and utilization.

Ethereum can be considered the second generation of blockchain technology. By providing separation between the application and the infrastructure layers, Ethereum provides a base for application developers to create decentralized applications over the blockchain. This is done, for example, by creating smart contracts, which can be immutable pieces of software running in a decentralized manner over nodes in the network under the promise of full consensus upon the execution of its terms.

Before Ethereum, decentralized applications like Bitcoin were implemented as a monolith mixing both the application and the custom-fitted infrastructure for running this specific application. Recent increases in decentralized application development in can be attributed to this separation of application from its infrastructure, as the barriers for their implementation have been greatly reduced. However, significant parts of Ethereum remain as working proofs of concept unable to run actual consumer applications on production.

The described technologies can be configured to implement the next generation of blockchain infrastructure that allows real-world consumer applications to decentralize. The described blockchain infrastructure and related technologies enable the implementation of decentralized consumer applications in real world production environments.

Many consumer apps use cloud services as their infrastructure for centralized IT services. Just as large entities rely on cloud providers to provide the infrastructure for their centralized consumer app backends, such entities can utilize the described technologies to provide infrastructure for decentralized applications.

In certain implementations, the described decentralized systems may not necessarily be decentralized end-to-end. For example, in certain implementations parts of the system can remain centralized. This has a great effect on efficiency since centralized infrastructure can be faster and cheaper than decentralized infrastructure.

Additionally, various systems often span over more than one blockchain. Different blockchain implementations are better suited for different goals, even in the same application.

The described technologies include a platform that is a decentralized network providing blockchain Infrastructure as a Service (IaaS) for large scale consumer applications. The described technologies provide the cloud infrastructure to run these decentralized applications and facilitate this transition.

Among the infrastructure offerings of the described platform are consensus-based decentralized compute services, consensus-based decentralized storage services and consensus as a service (CaaS).

The described platform can also provide services and/or related functionality pertaining to decentralized-consensus compute. This can include, for example, compute services that enable developers of decentralized applications to run their apps over the network and execute their code on the various nodes. Applications are executed in a fully decentralized and secure way over multiple independent nodes. The results of execution undergo consensus ensure a single coherent outcome emerges.

The described platform can also provide services and/or related functionality pertaining to decentralized-consensus storage—This can include, for example, storage services that enable developers of decentralized applications to store data over the network. Data is replicated and sharded between multiple independent nodes and stored securely in a fully decentralized manner. Storage enforces data to be in consensus, making sure there are no inconsistencies between nodes.

The described platform can also provide services and/or related functionality pertaining to consensus as a service. Since the described network is decentralized and comprised of independent nodes owned or operated by various organizations, the ability to reach consensus between these nodes is a core underlying capability of the network. The consensus layer of the described technologies is architected to be modular and allow additional infrastructure layers, such as compute and storage to be built on top of it. It also allows its users to reach consensus independently of the other services. For example, CaaS can be used to notarize documents, or inputs from decentralized oracles. Using the described technologies' inherent multi-chain connectors, CaaS can also be used to notarize states in other blockchain platforms or execute atomic swaps between platforms.

The described platform can also provide services and/or related functionality pertaining to Service Level Agreements (SLAs). This can include, for example, defining a commitment between the service provider and a service user. Particular aspects of the service—like minimum quality, availability, responsiveness—are agreed upon in advance with detailed mechanisms to guarantee the SLA in practice or compensate the user if the SLA is not met. In the described technologies, SLAs are much more than traditional agreements between parties, as they are implemented as a direct part of the protocol and are integral to network design. SLAs are important for consumer apps in order to increase the predictability of the service level. Consumer expectations are high and even small disruptions in the availability of an app causes users to leave. A blockchain platform will bring little value to its applications if it fails to perform when congested, even if it provides magnificent performance and ultra-low fees.

The described platform can also provide services and/or related functionality pertaining to consumer scale. Consumer apps serving millions of end users often have aggressive scaling demands—e.g., for the number of users, message throughput and message latency. If handled over blockchain technology, each ride of a ride-sharing service may consist of several transactions: ordering the ride, driver taking the ride, payment, review etc. Each of these transactions may need to be processed almost immediately to accommodate an efficient transaction between the rider and the driver. Using blockchain terminology, message throughput and latency translate to transaction throughput and confirmation time.

Consumer scale does not only apply to raw network properties like throughput and latency. Scale influences almost every aspect of platform design. Consider the scalability of the fee model for example. Infrastructure fees with a fixed cost per transaction that scale linearly with the number of transactions may provide a poor framework for consumer apps to grow, especially for mass usage patterns like microtransactions.

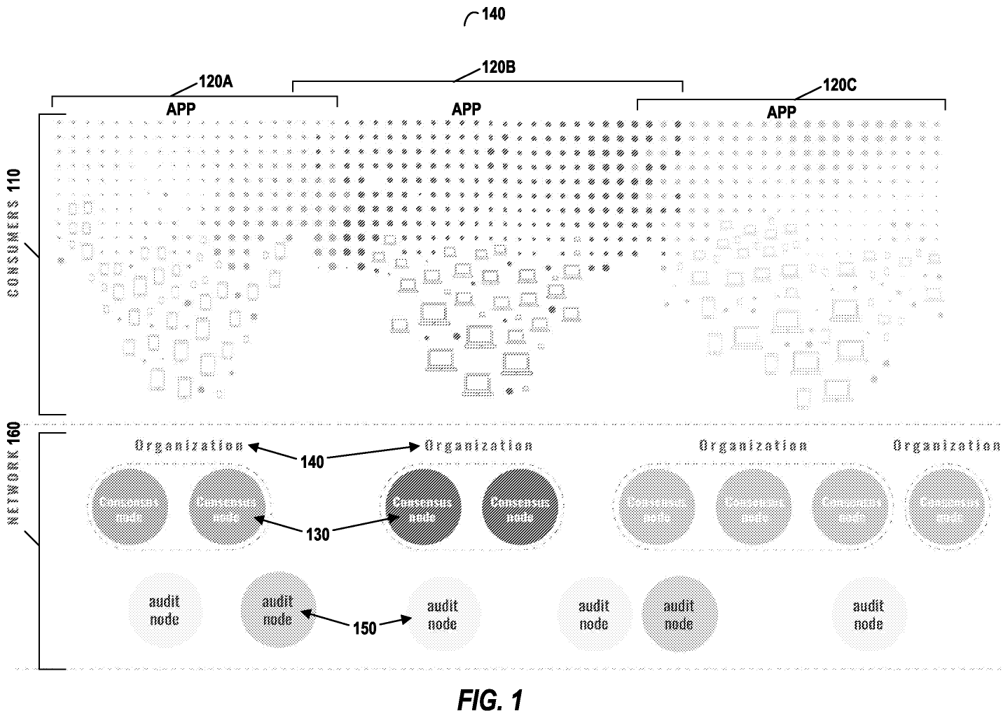

The described technologies include a blockchain infrastructure for large scale consumer apps. As such, we can categorize several distinct types of entities participating in the network, such as are shown in FIG. 1 and described herein.

Consumers 110 can include end users in the network who use the apps that are running on top of it. They make up the vast majority of wallet holders for currency-based products. Consumers may gain access to the network by using a mobile app or a website. In certain implementations, consumers may not have direct access to the described network and may not operate nodes like in alternative blockchain implementations such as Bitcoin. Access to the network can be provided through an app.

Usage profiles on mobile apps and websites are characterized by low availability of resources (low computational ability, low memory and low persistent disk storage). Network connectivity may be intermittent without a guarantee of how often consumers are online and for how long.

Apps 120A-120C can include applications, service, etc. running on top of the blockchain infrastructure, performing transactions for the benefit of consumers. Examples include instant messaging apps, ridesharing apps, etc. The described technologies can further provide computing resources for such consumer apps to meet the high expectations of consumers with respect to network scale, responsiveness, etc.

Consensus nodes 130 can include computing devices, servers, etc. that participate in the described consensus process and provide the referenced compute and storage resources to execute the referenced decentralized apps 120 on top of the described blockchain infrastructure. Nodes can be owned and operated by various entities/organizations 140 and each of the organizations can operate multiple nodes.

Nodes participate in the described network 160 by running the disclosed software stack—e.g., source code, instructions, applications, etc. through which the described functionality can be implemented. In certain implementations, the collection of nodes in the network may not have any centralized point of governance.

Audit nodes 150 can be computing devices, servers, etc. in the network 160 that are configured to add additional layer(s) of security by public audit of the blockchain. In certain implementations, audit nodes do not take an active part in the consensus process itself and do not have the capability to write data to storage or close blocks. As such, unreliable behavior by audit nodes, such as intermittent network connection or downtime, does not have a direct negative effect on the overall performance of the network.

In certain implementations, audit nodes also participate in the network by running the same or similar software stack as consensus nodes. In certain implementations, such audit nodes do not need or have a centralized point of governance. Any entity can operate audit nodes to contribute to the security of the network. In certain implementations, node operation can be incentivized by the token incentive/economic model.

The described technologies can include infrastructure which can include nodes of the network running the referenced software stack to provide the core competence of an infrastructure layer for the developers of consumer oriented decentralized apps. This offering includes consensus-based compute, consensus-based storage services and CaaS, as described herein.

The described technologies can also include specialized infrastructure. For example, decentralized analytics can be enabled via the described technologies. By way of illustration, many applications that use the described technologies may need a data and business intelligence layer (BI) but don't have the resources to develop or maintain their own solution. Reliance on a BI solution offered by a centralized party may be problematic since it may be difficult to base significant decisions on data originating from a single party (that may not be trustworthy). Accordingly, a decentralized solution can be advantageous. For example, using the described technologies, an established BI software vendor can develop a decentralized version of their analytics platform that interfaces with the described technologies to provide the infrastructure to application developers via APIs directly accessible from the described smart contracts. It should be understood that the referenced scenarios are provided by way of illustration and that that the described technologies can also include tools and integration points such as back-office software, oracles, integration ERP/CRM platforms, other types of storage and databases that go beyond a naive key-value store, etc.

In certain implementations, the described technologies can also provide an infrastructure marketplace/ecosystem, e.g., a ‘one stop shop’ for decentralized application developers. Such a platform can carry the foundation for decentralization and empower specialized complementary infrastructure solutions by third parties. This ecosystem establishes an economy for services based on the described token. Decentralized application developers therefore have a single integration channel and a common language for all of their decentralized technology needs.

As the native token for the network, the described platform can utilize the referenced token to fuel network operation and provide the means to pay the fees involved with operation of the consensus layer, execution of smart contracts and consensus-based storage, etc. The economic/fee model can serve as incentive for nodes to allocate resources for operating nodes and ensures an SLA consistent with consumer expectations (e.g., for predictable and stable service, availability, performance, degree of security, etc.). in certain implementations, the referenced token is not only the driver for the described core infrastructure, but for the entire ecosystem. It fuels an infrastructure marketplace and serves as the means of payment for third party infrastructure providers which choose to provide specialized decentralized infrastructure solutions on top of the platform.

In certain implementations, the described technologies can also include a billing subsystem. The described platform distinguishes between billing and accounting. The billing subsystem can be based on the token and provides the flexibility to be performed in intervals (e.g., monthly). Accounting can be performed separately per transaction and on demand with domain-specific metrics (e.g., transaction throughput or storage used on chain). This separation adds additional flexibility (as compared to the rigid per-transaction billing and fee model used in other solutions).

In certain implementations, the described technologies can also provide programmable fee models. For example, different applications prefer to collect fees for infrastructure costs in different ways. Microtransaction-oriented peer-to-peer marketplaces hosted on digital services prefer that the digital services will subsidize the fees for infrastructure (and obscure them from their end users). This is achieved via the described technologies through subscriptions. Subscriptions are designed for the developers of decentralized consumer applications which are often responsible for payment for the infrastructure services.

The described technologies are configured to support alternative models. For example, consumer applications where larger sums change hands in a less frequent manner (e.g., in a decentralized apartment sharing application) may prefer that the party that originates the transaction will pay its fee and/or make the fee proportional to the amount paid (despite the actual cost of infrastructure being constant). In other products, it may be preferable for the recipient to fund the fees.

One approach dealing with these varying demands is to move elements of this decision from the infrastructure layer to the application layer. By adding a degree of programmability to the fee model, with a smart contact that specifies how the fee is paid, applications can maintain the freedom to adjust the fee model to their needs. This also resolves another common challenge where the fee is paid with one token and the transaction is performed with another, requiring users to hold balances in both tokens in order to operate.

In certain implementations, the described technologies can also provide various economy incentives. One of the main benefits of basing economies on a token instead of traditional fiat currency is the ability to design an inherent system of incentives that will govern the system and steer it towards a global set of predefined goals. Bitcoin's goal, for example, is relying on the native token to incentivize the security of the network and rewards nodes for securely closing blocks with Proof of Work. In the described technologies, compensation to validators can be based on fees (no inflation to the token supply) from the very beginning. Moreover, whereas fees distribute the burden relative to the amount of actual use of the validation services, generating rewards by inflation levies the cost of the reward on holders of the token relative to their holding amount. Like usage of property taxes to subsidize trade which creates a skewed market, using inflation to subsidize validation will lead app developers to make uneconomical choices.

The described token economy is designed to promote several aims, such as:

Incentivize nodes to maintain a high SLA [High server availability with no downtime, Secure servers against hacking and protect their private keys, Fast server hardware with a fast network connection, Uphold its commitments to other nodes (like dedication of resources), and regular server maintenance. Additionally, it can incentivize nodes not to fork the official token, e.g., by taking part of the official ecosystem and not split apart, participating in the consensus process with other network members, and incentivize new consumer brands and organizations to join the network. Moreover, it can incentivize nodes to update protocol versions regularly, e.g., by run the same protocol as everybody else, enabling fast end-of-life cycles for outdated versions, reducing maintenance costs. Additionally, it can incentivize nodes to audit the network, e.g., by public validation that the network is secure, and incentivize hackers to report vulnerabilities instead of exploiting them.

Other advantages of the referenced token economy include handling network over capacity gracefully and determining who gets service in this scenario; allowing applications to pay for dedicated resources such as throughput or storage; providing the necessary friction to prevent applications and users from spamming the network and paying for actual node server costs.

Besides the specific implementation details of the billing subsystem which controls how revenue from fees is distributed across the network, other core aspects of the described platform are used to implement the economy incentives. The first is a reputation system for nodes calculated during the consensus process and facilitated by the platform consensus algorithms such as the described Consensus Algorithm. The second is declared use of tokens according to the initial token distribution. Over half of the token reserve in the described ecosystem can be intended for helping established consumer brands join the ecosystem through partnerships without having to bear high entry costs.

Token Implementation—the described platform can implement a billing subsystem, e.g., over the Ethereum blockchain. These ecosystem integrations with exchanges, third party wallets and hardware wallets can be advantageous for the target audience of the billing subsystem, entities and professionals, as they are often required to manage large amounts of money in the form of cryptocurrencies.

Implementing the referenced token can also provide a production use case for core platform features like Polyglot Cross-Chain Contracts, as the subscription smart contracts running over the disclosed platform can access billing information found on the Ethereum blockchain. This is an example where a multi chain hybrid can be advantageous, where two blockchains can be used side by side, focusing on their relative advantages.

Polyglot Microservices—In the evolution of software systems architecture, traditional systems grew gradually from the initial single program to complete systems. Initially, systems were very simple with all functionality in a single program—what is considered a monolith. As functionality was added to the system, both its codebase and group of contributing developers grew. Gradual growth then lead to decomposition of the project to separate modules following the separation of concerns principle. Over the years, well-architected modular systems proved to work well for scaling functionality and for scaling development teams.

The Internet revolution brought about new challenges to systems design, as modern systems commonly need to work at massive scales—interfacing with other systems and millions of end users. This leads to changes in both ends of the engineering process. On the development end, the complexity of such systems requires new development paradigms such as refactoring, agile development, continuous deployment and build-measure-learn cycles. On the operational end, it leads to dependence on intricate infrastructure to enable scaling the throughput of overflowing interfaces. Both changes prove to be hard to apply in modular systems that suffer from delicate module interdependencies. This hardship lead to the evolution of service-oriented architecture and microservices design methodology, where each functional component is implemented as a separate, simple and focused product.

It is easy to observe that most current-generation blockchain platforms are built as monoliths. This not only shows the immature state of their development, but also hampers the ability to evolve and extend the functionality of systems based on these platforms. Moreover, in high-complexity open source projects, the reliance on well-acknowledged libraries and frameworks becomes limited when monoliths are constrained to design choices optimal for just some of their functions. The optimal environments for developing high-performance cryptography are different from those optimal for decentralized storage or from those for high performance networking and so on. The microservices architecture enables a system to be polyglot, i.e. use different programming languages and frameworks for the different services. Such an approach allows for higher quality services, and better usage of resources such as open source solutions and engineering talent with expertise in relevant domains.

Specification as Code—As many software engineers know, a specification document grows stale the minute it gets published—if not before. Therefore, we strive for executable specifications that will trigger conspicuous alerts upon failing. By using executable specifications, we ascertain that at no point in time does a codebase diverge from its specification, thus assuring that backwards compatibility and correctness are never compromised.

The distributed and decentralized nature of a blockchain network makes utilizing executable specifications even more important as the developers have little control over the deployment lifecycle of the services, so rolling back a deployment that broke an API or introduced a bug is not a viable option. Therefore, the described technologies enable workflows that make extensive use of executable specifications in two major categories: using Protocol Buffers for generating our API schemas, and using Test-Driven Development (TDD) for achieving highly testable code.

Protocol Buffers (or protobuf) is an Interface Definition Language (IDL) that is programming-language-agnostic and allows defining APIs with backward and forward-compatibility in mind. This creates a clear distinction between the code that defines an API specification and the language and code used to implement it. If a developer changes an implementation in a way that breaks an API, static type-checking will fail the build and an alert will be sent to the developer immediately upon failure. An added value of using a language-agnostic IDL is as an enabler for writing polyglot microservice, as the API between each pair of microservices is not defined in any specific language.

Test-Driven Development (TDD) is a methodology in which each required behavior is coded into unit tests before the coding the behavior itself. In practice, it means the developer starts by defining the missing behavior, thus creating a test that fails and making sure the failures are as expected. Only then can he go on to implement the code that makes that test pass. Pursuing this methodology assures that no untested code ever gets into the source code repository. Next, the code is reviewed, but unlike regular code review, the reviewer focuses on validating the correctness of the test (representing what the code does) rather than that of the code itself (how it does it). The tests are written in a semantic language describing the business domain (for instance, transferring some funds between two addresses) rather than the specific implementation; changing the implementation does not affect the test. Practice shows that TDD leads to shorter, more concise code and that the coding process comprises of more cycles of refactoring, thus reducing technical debt.

Meta Programming—As the distributed and decentralized nature of a blockchain network imposes engineering challenges that are not present in a traditional deployment, the need arises for creative solutions allowing to circumvent some of these limitations. The described platform utilizes meta programming for components that can support Over The Air (OTA) deployment. Other blockchain networks such as Ethereum offer the concept of smart contracts as a way to execute user-deployable code. The described platform further implements these ideas and extends them for engineering-facing problems such as deployment and provisioning.

One area where meta programming is utilized is resource management and provisioning. This is implemented as hot-deployable code not unlike smart contracts, running on an instance of the network itself (which can be thought of as a meta network), controlling the way resources are provisioned. For example, new virtual machines may automatically be instantiated to increase network capacity when a new member joins the ecosystem—particularly when this member is paying for dedicated resources. Since it is difficult to foresee the types of limitations and challenges when onboarding new members to the ecosystem, making this area of the management code OTA-deployable can be advantageous. An added value of this approach is that the developers have immediate visibility into the platform's runtime, as they will be users of the platform themselves.

Another example is a public DNS-like service which enables the resolution of a public address in a more user-friendly format (alternatively, it can be used to shuffle between multiple addresses). Implementing such an address resolution mechanism as a smart contract makes it easier to maintain than making it part of the platform's native core.

Universal Addressing—Addressing is an important topic in blockchain infrastructure controlling the scheme of how various resources are labeled and referred to across the system. Logical entities that have a distinct address include token accounts, smart contracts and their stored variables.

Different blockchain implementations have adopted different addressing schemes. Some addressing schemes, such as Schnorr public key based, enable native support for multi-signatures. Other addressing schemes have wider ecosystem presence and are supported by more hardware devices and HSMs. Moreover, an addressing scheme that is compatible with the one used by another blockchain implementation allows end users the convenience of using the same public address across multiple platforms.

In order to promote interoperability between blockchain implementations and allow for easier migration onto the platform, the described technologies support a universal signature and addressing scheme. This method allows applications and users to use a range of popular addressing schemes side by side by specifying the type of address next to the address itself. From an architecture perspective, addressing schemes are managed by a dedicated module which can be upgraded to support additional schemes.

Network Owned Secrets—In centralized systems, secure operations are commonly based on secrets owned by the governing service which can be used to sign, encrypt or decrypt data. As decentralized networks are comprised of independent nodes in a trustless setting, applying a similar method is not as straightforward. Secrets can only be held by individual nodes. The network as a whole is usually unable to hold a shared secret and use if for secure operations, due to the open and decentralized nature of the system, this secret will easily leak outside.

This limitation often causes blockchain implementations to rely on trust for scenarios where trust should not have normally been required. An example is how the client of an end user communicates with the network and performs queries on its state like checking the user's balance. Assuming the client cannot run a full node that synchronizes with the network and performs the complete suite of resource intensive validations, some compromises must be made. A common workaround is for the client to communicate with the network through a specific gateway node and delegate some of the validations to it. This means a client query for network state needs to trust the gateway node to provide an honest response. Some improvements over this approach include redundancy tactics of querying multiple gateway nodes at once, choosing the gateway node randomly, etc.

Network owned secrets is a cryptographic protocol introduced by the disclosed platform, that provides the ability to hold a shared secret securely in a decentralized network. None of the nodes may have direct knowledge of this secret, and only a combined effort of a specified majority among them can facilitate this secret to perform a secure operation like signing, encrypting or decrypting data. The mechanism relies on a cryptographic primitive called threshold encryption in conjunction with the disclosed Consensus Algorithm. Among the benefits of this method is that the combined signature is only produced after reaching a threshold amount of signatures by individual nodes, each using their own individual secret that no other node knows. Thus, the described technologies create a combined signature that can effectively be considered as the signature of the entire network. When the network as a whole has the parallel of a private and public key, many useful secure operations can be implemented.

Network owned secrets provide the ability for secure interaction with the network without the need to trust specific nodes. Consider a client that desires to perform a smart contract calculation and is unable to run a full node. Instead of querying one of the network nodes as a gateway and trusting its response, by using a network secret to sign the combined response of multiple nodes, the client can verify the response simply by checking the signature.

Another interesting capability gained from the network's ability to own secrets is holding assets or accounts on the network level. Consider the requirement to implement a smart contract over the platform that controls an account on a different blockchain like Ethereum. Normally, this requirement would not have been possible to implement since smart contracts cannot hold secrets. Using a network owned secret, though, a private key can be generated by the collective for nodes after consensus. This private key is unknown to any of the individual nodes and can be used to access an external Ethereum wallet securely. Moreover, smart contracts can be used to provide key services such as key management, DRM, etc.

The architecture of the described technologies consists of multiple layers, responsible for different functions in the system. The layers and services are built such that they can operate on different machines and scale independently as needed. In certain implementations, the architecture attempts to separate services and modules as much as possible within a layer in order to enable flexibility, upgradability and interoperability.

One component of the architecture is the support of virtual blockchains—multiple parallel instances of the consensus, state and storage layers; that provide the illusion of a separate dedicated blockchain over a shared physical node environment. The concept of blockchain virtualization is discussed in greater detail in the following sections.

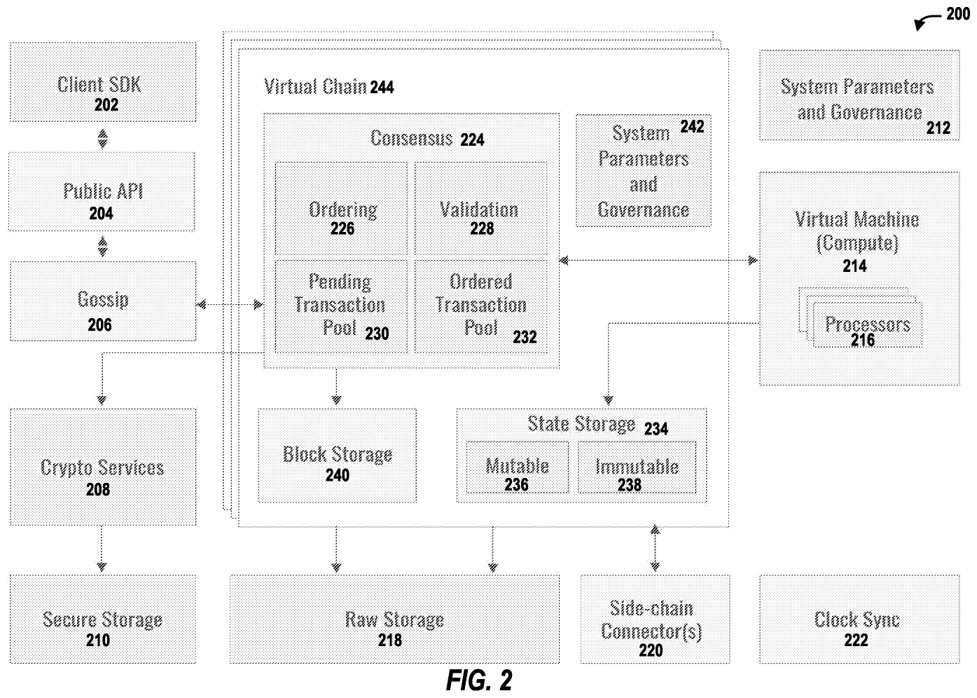

FIG. 2 depicts certain aspects of the architecture 200 of various infrastructure layers and services described herein.

Among the elements depicted in FIG. 2 are:

Client SDK 202—A client-side library for mobile and web apps that connects end users to the network. The SDK can sign requests and verify responses without relying on trusted nodes.

Public API 204—A microservice that exposes all public web API to clients (such as REST or JSON-RPC). Provides the endpoint handling all end user transactions and queries.

Gossip 206—A microservice that provides efficient one-to-many and one-to-one communication between nodes in the network.

Crypto services 208—A library and service providing the low-level cryptographic routines and services like signatures, hashes and encryption. Has both native and non-native fallbacks.

Secure storage 210—A library and service that store secrets like private keys in a secure manner. Uses HSM when available, relying on dedicated hardware and tamper-resistant enclosures.

System Parameters and Governance 212—Holds infrastructure configuration parameters and handles updates and provisioning.

Virtual Machine (Compute) 214—A microservice that owns the execution of transactions and smart contracts, serving all virtual chains. The compute layer holds transient state for non-final execution and side-chain data.

Processors 216—A set of microservices providing the actual runtime environments needed for the execution of smart contracts in various languages (EVM, Python, Java, JavaScript, etc.).

Raw storage 218—A layer responsible for storing and retrieving raw data on local machines.

Side-chain connector(s) 220—A set of microservices providing cross-chain interoperability with third party blockchains like Ethereum. Provides access under consensus of the third party.

Clock sync 222—A microservice responsible for synchronizing clocks between different machines, nodes and services. Provides a consistent frame of reference for absolute time.

Consensus 224—A microservice instantiated per virtual chain that is responsible for achieving agreement among nodes on the order of transactions and their validity. Implements the consensus algorithm. Consists of the sub-layers: ordering 226, validation 228, transaction pool(s) 230, 232.

State storage 234—A microservice instantiated per virtual chain that holds the mutable 236 and immutable 238 state that is under consensus. Manages efficient caching, sharding and redundancy for the state data. Accessed by the Virtual Machine and Public API.

Block storage 240—A microservice instantiated per virtual chain that holds the incremental long-term journal of all previous closed blocks. Manages efficient sharding and redundancy for the blocks data. Used to generate and validate the state.

System Parameters and Governance 242—Instantiated per virtual chain 244 and holds the virtual chain specific configuration parameters and handles updates and provisioning.

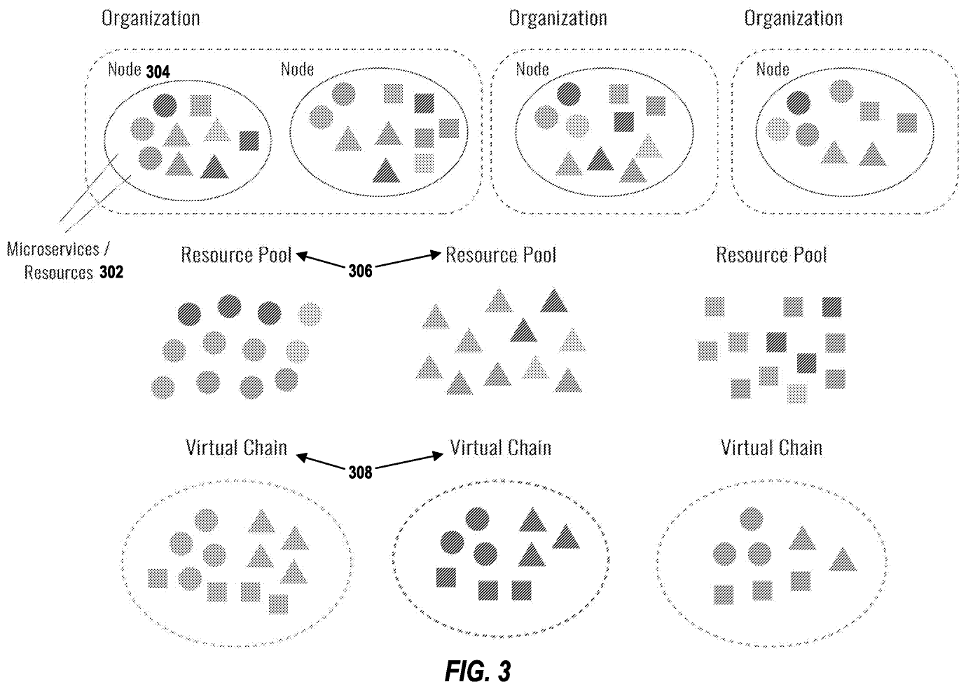

Further aspects of the described architecture are depicted in FIG. 3. In certain implementations, the architecture is comprised of a set of microservices 302 providing different types of resources to the network. Each type of resource can be scaled separately according to the actual requirements of the network. A service like Public API can be scaled aggressively by launching multiple instances as more concurrent end users connect to the network, compared to the consensus service that is instantiated per node based on the number of virtual chains.

Different applications running on top of the described platform may have different requirements for different resources. For example, a compute intensive application may require a large capacity of decentralized compute resources while a database application may require a large capacity of decentralized storage. Moreover, the amount of resources is expected to change over time with the introduction of new applications and the evolution of their needs.

In order to efficiently utilize the resources and microservices available on each node 304, they are regarded as a shared pool of resources 306 that is then allocated to different virtual chains 308 based on their SLA requirements. Some resources may be dedicated to a virtual chain whereas others are allocated dynamically based on demand. An architecture based on resource pools effectively utilizes the varying capabilities of heterogeneous nodes and supports an elastic resource capacity. In order to uphold the overall SLA commitments of the network, nodes are economically incentivized to add resources as needed.

Pragmatic decentralization and trust—Consensus is one of the subsystems in a blockchain infrastructure. Consensus addresses the problem of agreement in a decentralized system, where the selection between different possible agreements could create profits or losses to different parties.

Companies/brands are often centralized entities with one leadership and one policy. They often rely on centralized delivery channels to reach consumers (e.g. app stores and centrally branded/managed websites hosted on centrally-managed servers). In a scenario in which a consumer types their secret passphrase into a mobile app wallet, the consumer must trust that the developer of this mobile app isn't stealing their private key, abusing it or transmitting it outside. When interacting with blockchain, it will be code created and signed by brands that will ultimately interface, on behalf of their users, with decentralized apps.

Various consensus models can be configured accordingly. For example, they can be configured such that a user's voting power is delegated to an entity whose code they are using. Even in models like Delegated Proof of Stake (DPoS), the voting power in the delegate election is implicitly delegated to the brand.

In many decentralized networks, political power is used for decisions including real-time validation of transactions, and governance of the network itself (agreeing on protocol upgrades, parameter changes, forks to the blockchain, etc.).

The effect of political power in real time validation is limited when the protocol is well-defined, because the fundamental rules are axiomatic to the operation of the network. For example, a decentralized ledger would not enable any verifier—no matter how powerful—to approve transactions that are not signed by the payer. If it did so, it violated the rules of the protocol, so the allegedly-approved transactions will either be ignored by the network, or the network will halt because the consensus broke. Accordingly, egalitarian distributions of power, which make it harder to stage such attacks, lead to more robust and sustainable platforms.

Manipulations that do not break the protocol are limited, then, to undetectable violations of the protocol; for example, deliberately failing to propagate transactions, manipulating the order of transactions within a block, selfish mining, and so on. The ability to abuse power in this real-time validation can be further limited if the protocol is designed in a way that limits validators' ability to apply such manipulations.

With respect to blockchain governance, stakeholders include users, decentralized app developers catering to the users, and network infrastructure operators (e.g. full nodes, miners).

Developers' interest in infrastructure choices are usually well aligned with the users', except for situations where a proposed change could be used by an incumbent to fend off competition. App vendors may also be divided on their preferences between newer and field-proven technologies. Vendors of mature and established apps tend to be risk-averse and prefer waiting for technologies to ripen, whereas fledgling apps see value in adopting avant-garde technologies that have greater potential to disrupt incumbents. Platform virtualization can mitigate many of these conflicts, as it allows each application to govern many aspects of its own infrastructure independently from others.

Proof of Work—If most people are honest, a majority vote on the integrity of a public ledger is a straightforward consensus that is decentralized, permissionless and open. But when relying on digital identities, majorities are an elusive concept as the cost of generating new identities is negligible (“Sybil Attacks”). One solution is proof of work (PoW), in which suffrage is subject to spending computer resources and energy on solving a cryptographic puzzle.

A PoW ledger arrives at consensus over time:anyone can be the public verifier for a set of transactions (usually, a “block”), if they are first to solve a PoW puzzle; their efforts on the puzzle will be compensated by a cryptocurrency reward. Consensus on the validity of a block builds gradually, as future blocks refer to our block as their predecessor. A perpetrator will be at loss for trying to publicly validate an invalid block, because his expenditure on the PoW will not be reimbursed if his (invalid) block is not referred to by future blocks.

Although PoW ledgers achieve a decentralized, permissionless and open consensus, drawbacks remain. For PoW to be secure, the cost of solving the puzzles must be proportional to the value of the underlying assets; the global impact of this on mass-market ledgers is concerning. As cryptocurrencies reach mass market audiences and significantly grow in value and transaction volumes, PoW ledgers can become unsustainable due the amount of emissions involved with their operation. Naturally, these costs are imposed on the users of the Infrastructure as fees and inflation; costs of using PoW networks are higher than those of the alternatives. In order to reach the massive scale required for consumer apps, lowering infrastructure costs is also an advantage of the disclosed platform.

PoW poses other challenges to mass-market adoption. One is with the governance of such networks; in addition to the inherent complexities of governing a decentralized movement, a side effect of the proliferation of PoW is that mining has become a business of specialists, adding another powerful, heavily invested stakeholder in the system whose interests aren't aligned with those of users or app vendors (as discussed above).

Another barrier to using PoW in mass-market applications is the inherent latency associated with eventual consensus. The acceptance of a block is determined by the depth or weight of other blocks referring to that block; this weight accumulates slowly as blocks cannot be created too fast without raising the probability of conflicts, which in blockchain systems come as forks to the chain. Newer protocols can significantly reduce this latency by using data structures that embrace forks as a valid state of the blocks' formation. For example, the design and validation of the SPECTRE protocol implements a block-DAG (Directed Acyclic Graph) to replace the conventional block chain. Such work advances PoW decentralized payment ledgers beyond their current limitations, but does not offer a good solution for other systems such as smart contracts, as their use entails very high complexity of calculating the system state.

Proof of Stake (‘PoS’)—An alternative means for countering Sybil attacks is to tie suffrage to ownership of a digital asset, usually a cryptocurrency. On the face of it, PoS provides an elegant alternative to PoW, without some of the costs and energy waste associated with it. But the fact that PoS schemes don't require verifiers to risk any exoteric resources requires dealing with additional challenges.

One challenge is that participation in the validation process is not a direct concern of most users of the platform. Someone using a blockchain for transferring value, or a user of an application that makes use of smart contracts, would usually not be aware of the mechanics of the decentralized ledger, and is likely to have little motivation to participate in the process. This is problematic for real-time validation of transactions, in which the validator is required to be constantly online and to allocate network and processing resources to a nonstop feed of transactions.

Some platforms try to replicate the ecosystem of specialist miners, commonplace in PoW systems. This includes a wide variety of models, ranging from purely permissionless models in which would-be verifiers need to stake or burn tokens as a form of earnestness, to semi-permissioned models such as delegation, where stake-owners trust their voting rights to a specialist. Though the models greatly differ, all face the same fundamental challenges of a lack of incentives for validators to act honestly and an increased risk of formation of a dishonest majority.

There are attempts at creating a full-participation, direct voting PoS systems. One example very weighs a random sortition by user stake, thus requiring only a small sample of users to participate in validation at any given moment as a form of ‘jury duty.’ However, it is important to note that at the moment there are significant practical barriers to their implementation in mainstream applications. Mass-market users cannot be expected to be active in the technical process of transaction validation, nor to verify the software they are using for such validation; they merely download an app from an app-store. In practice, this gives the app developers total control over a user's voting power, making the system just as good as a delegated PoS system with all its disadvantages.

Permissioned models—The idealistic nature of the blockchain community has traditionally pulled towards consensus designs that are decentralized, permissionless, open and transparent. By relaxing the constraint on being permissionless, Sybil attacks are no longer a concern, and faster, more efficient consensus algorithms can be used. Furthermore, permissioned validation also entails that the identity of the validators is known to all. Not hiding behind the veil of anonymity, validators may be required to make public commitments to abide by the rules of the protocol; in such case even the rules that cannot be enforced using technical measures, may be enforceable in commercial lawsuits.

There are various forms for setting up a public permissioned network in decentralized context. In a consortium, a central body governs the network thus distributing the validation permissions. Real-time validation permissions may still be considered decentralized, although the question of whether the governing body carries liability for operating the network remains. A federation leaves the governance decentralized: permissions are not common to the network but are rather specified by each user or app developer. Different users may be seeing different projections of the ledger, when they don't share the same set of permissioned validators. In some architectures, this adds significant complexity to the consensus protocol and ledger structures, however it remains very simple in platforms that provide blockchain virtualization.

Federated models for public blockchains are present as in projects like Ripple and Stellar. These projects maintain a high degree of decentralization, openness and transparency, where any party can set up a node and verify the history for transaction integrity. The permissioned aspect of the model comes into play in the validation of new transactions being written onto the chain. Every node can specify the list of nodes it trusts to participate in the validation of its transactions, thus creating a combination of groups with differing consensus quorums.

As described herein, federated blockchains offer an ideal solution for mass market consumer applications, both in performance and in alignment with the interests of the consumers. Though consumers may not necessarily be directly involved in governance of the blockchain; any practical system wishing to align with the long-term interest of the consumer can empower app developers or interested third parties such as miners. App developers are already the trusted, dominant stakeholder in the app market, entrusting them to this power maximizes the benefit for the consumer. Distribution of power between developers should be such that limits the individual power held by each one separately. All these requirements are best met by federated consensus models.

In certain implementations, the governance of the federation itself (accepting and rejecting of federation memberships; changes to federation members' permissions; changes to the federation rules) can be replaced with a permissionless consensus model (such as delegated PoS). Such structure can preserve many advantages of the pure federated model.

As blockchain technology reaches mass-market apps, classic forms of decentralized consensus may be inapplicable. The volumes and values of transactions in a mass-market setting may cause PoW consensus to be too expensive, too slow and cause too much environmental damage. The fact that the apps themselves, rather than the mass-market users, are in control of the users' voting power make PoS too risky of a choice for such a platform. Moreover, the typical pattern of app popularity is that of extreme inequality: at any given time and for almost any segment, a handful of popular apps overpower the infinitely long tail of less-popular apps. Because the ideal power distribution should be one that avoids significant inequalities in power, the described technologies can be configured to create a system that assures an upper limit to any one stakeholder's power.

Accordingly, the described technologies further incorporate a consensus algorithm tailored to the ideals of mass-market apps. One premise is that app vendors hold most of the power in a platform that caters to apps, and that a consensus protocol must be designed from ground up to ensure that vendors' interests are aligned with each other and with the interests of their users. For network governance, this means the protocol has to work natively with chain virtualization, as it allows the governance of each app to be separate from that of other apps. Beyond that, voting power is distributed equally between known and authorized verifiers, thus limiting the power held by a single voter. For real-time validation, we require the protocol to be fast, immediately-final and for it to be impractical for validators to manipulate the selection and ordering of transactions.

Among the requirements and features of the described algorithm and associated technologies include:

Finality of consensus results—The disclosed consensus algorithm and associated technologies provides immediate transaction finality. In business applications, transaction finality is a highly desirable property enabling stakeholders to provide intended services immediately once the transaction is executed. Unlike the probabilistic finality of transactions in systems like Bitcoin, stakeholders are not required to wait for multiple blocks in order to gain sufficient confidence that a transaction will not be reversed.

The finality property also enables efficient usage of the state database. The state database can be updated under consensus at the closure of each block and its validity can be easily validated by its root hash. Keeping a state database that is always under consensus prevents the need for high bandwidth access to a large transaction journal and the need for additional checkpoint mechanisms.

Fair Ordering using Opaque Pre-Consensus Transactions—Many algorithms rely on full-nodes or miners to decide the fair order in which new transactions are inserted into blocks, without defining rules or method to enforce fairness. Furthermore, some networks give miners the freedom to choose which transactions to include in a block, thus creating preference for high-fee transactions and enabling censorship.

In certain implementations, the disclosed consensus algorithm and associated technologies uses opaque pre-consensus transactions to ensure fairness and censorship resistance. Transactions are encrypted by end-users before transmission and are only decrypted after consensus on their ordering was reached. This mechanism ensures clients receive fair service without a need to trust nodes or to provide them with direct incentives. Separation of Ordering from Validation—Pending encrypted transactions are first ordered, and once consensus on the ordering is achieved, are the decrypted transactions executed, achieving consensus on their validation. Separation of ordering from validation enables higher scalability and a higher transaction rate. Moreover, it allows the system to optimize the properties for each stage, such as committee size or the use of encrypted data.

Efficient Consensus by Committees—The amount of communication in consensus protocols is highly dependent on the number of nodes participating in the consensus. On one hand, it can be advantageous to increase the number of nodes in order to increase the decentralization and security. On the other hand, it can also be advantageous to control the amount of inter-node communication in order to reduce confirmation time and increase throughput. Using randomly selected, unpredictable committees that take active part in a block selection allows the system to increase the overall number of nodes while maintaining an upper bound on communication overhead.

Committee and Leader Election Using Sortition—Many Byzantine Fault Tolerance algorithms, such as PBFT, are based on an election of a primary or a leader node. In order to ensure liveliness, these algorithms require mechanisms+to identify a faulty leader and act for its deposition. These mechanisms can be complex, rely on timeouts and result in a slow transition in cases where a new leader election is required. The transition overhead discourages frequent leader rotation resulting in imbalance and suboptimal fairness.

In order to efficiently and randomly elect different leaders for each consensus roundterm, the disclosed algorithm and associated technologies uses sortition for committee and leader election. For each block, the consensus nodes are sorted based on a hash of the decrypted data of the previously ordered block, which provides a random and consistent selection. Using the decryption that is only available after the previous block has reached consensus prevents a leader from manipulating the block data in order to control the next block committee members. The availability of a sorted list of the committee members enables efficient fault tolerant communication protocols. These can reduce the amount of network traffic and maximum propagation time, thus improving transaction rate and scalability.

Node Reputation System—The consensus algorithm operates in a Byzantine environment, where some of the nodes may be faulty or act maliciously. Moreover, not all the consensus nodes are homogeneous and their performance or responsiveness may vary. In order to rapidly identify faulty nodes, balance resources and incentivize nodes to behave according to the protocol, the disclosed consensus algorithm and associated technologies maintains a decentralized reputation system where every node is scored by its peers. Node reputation affects the political power of a node, such as its chance of being included in committees. Reputation also assists in economic incentivization, such as distribution of fees between operators.

A Service Level Agreement (SLA) is a contract that describes the official commitment between a service provider and a client. It describes the expected level of service, the metrics used to measure it and the penalties in case the agreed service level is not achieved. SLAs are widely used for services provided between organizations or even within an organization.

A separate SLA can be defined for each of the provided services. For example, in an IaaS platform, each of the core services (compute, storage, networking) can have their own SLA. Users may have a choice between different SLAs, enabling different customers to plan according to their needs. For example, an online consumer application may focus on availability and consistent performance. Alternatively, offline applications may prioritize average performance over consistency.

An SLA protects both the customer and the service provider. It prevents misunderstandings and misinterpretations by setting expectations explicitly. Moreover, an SLA helps customers predict the level of received service in advance and budget accordingly. For service providers, an SLA provides a means to estimate required resources and plan ahead.

While SLAs are prevalent for applications running on centralized IaaS platforms, they are lacking for decentralized ones. The inability to predict performance and costs reliably creates a challenge for consumer brands to transition to decentralized businesses.

Consumer applications require an environment with predictable performance, transaction rate, confirmation time and fee cost. A spike of 20% increase in traffic is difficult to handle by any infrastructure, centralized or not. However, an infrastructure solution that applies firm SLA rules and isolation among applications would have had minor impact on existing applications and would be more likely to contain this impact in agreed upon boundaries.

SLA in a Decentralized Context—One challenge in providing an SLA in an open and decentralized platform is that platform users don't have direct agreements with infrastructure providers, so they don't have a natural counterparty with which to make such an agreement.

Various services provided by the described technologies are provided by shared resources, but as shared resources get overloaded, the service level cannot be guaranteed. Application developers may purchase dedicated resources directly from operators of network nodes. By acquiring sufficient resources to support the throughput required for the operation of that application, developers can guarantee a minimal service level for their users. The described technologies can provide a marketplace infrastructure where app developers can purchase dedicated resources directly from node operators.

In certain implementations, acquisition of dedicated resources does not come in place of decentralization. The acquired capacity may not be provided directly to the purchaser, but rather added to the shared resource pool. So, in practice, acquiring the dedicated resources establishes an SLA between the node operator and the shared pool back-to-back with an SLA between the shared pool and the purchaser. In case the node operator fails to deliver the required capacity when the system is under load, a compensation amount will automatically be deducted from their fees. Yet, it is possible that other providers on the shared pool have vacant resources and the SLA with the purchaser can be fulfilled.

Predictable Fee Models—It can be appreciated that one of the main challenges facing application developers is unpredictability of fees. Budgeting is crucial for the success of consumer applications: product development is expensive, and entrepreneurs or entities want to know in advance, that if their app succeeds, they will get a return on their investment. To know that, they need to weigh in their operating costs. The described platform provides a pricing and fee model that is predictable and can be calculated in advance.

The fact that services are listed using the disclosed a token with floating exchange rate, creates risks for both service sellers and buyers. In case of exchange-rate fluctuations, the token may increase in value, effectively raising the infrastructure costs to platform users, or decrease in value, possibly making the operation of a validating node non-economical. Additionally, operation expenditures are exposed to price fluctuations of the underlying IT infrastructure (storage, processing, network access etc.), but their prices tend to decline gradually over time.

To accommodate price changes, on-demand service prices can be updated in a majority vote of the disclosed Federation, e.g., with a minimum of 30 day notice for price changes. In certain implementations, such price changes can be determined automatically, e.g., by pegging to an index of dedicated capacity prices, as these are determined by supply and demand in free market settings.

Dedicated, Reserved and On-Demand Resources—One of the challenges in dynamic resource management is the inherent trade-off between the ability to share resources and the ability to guarantee their availability. Resource allocation schemes include:

Dedicated resources—A physical resource is dedicated to the application, providing maximum isolation, high predictability and visibility. Dedicated resources are guaranteed to always be available for the customer. These resources must be paid for even when unused making this scheme of allocation the most expensive of the three.

Reserved resources—An amount of resources is provisioned in advance. Reserved resources may be guaranteed under some restrictions or prioritized over on-demand resources. As reserved resources are provisioned in advance, and allow the service provider better planning, they are typically provided with a significant discount over on-demand resources.

On-demand resources—Resources are shared between applications and are allocated on-the-fly based on availability. Payment can be based on actual usage. On-demand resources are recommended for low cost applications or for application with unpredictable workloads.

A common strategy for an application looking to optimize is to allocate a mix of resources. For example, an application may allocate dedicated resources to guarantee the minimum performance required for basic operation; reserved resources to meet a typical workload; and on-demand resources to accommodate peak usage.

Virtual Chains and Blockchain Virtualization—Blockchain virtualization implemented over the disclosed platform provides the illusion of a dedicated blockchain while running on top of a shared physical node infrastructure, thus enjoying the same security and decentralization provided by the shared environment. Virtualization separates the resources available to applications from the underplaying physical ones. The properties of blockchain virtualization include isolation, quality of service, SLA, control, governance and elastic resource capacity. Many blockchain implementations, like Ethereum, are shared, where multiple decentralized applications run side by side without isolation, suffering from unpredictable performance. Blockchain virtualization allows the disclosed technologies to overcome these limitations without compromising on the risks of a centralized or private infrastructure.

“Virtualization” broadly describes a layer of abstraction that provides separation of a logical resource from the underlying physical delivery of its function. With blockchain virtualization, each component of the blockchain infrastructure, such as the consensus, the state and block storage, and the virtual machine (compute) layer are virtualized. This allows virtual consensus instances to be allocated with a desired transaction confirmation rate that can differ across virtual chains. Moreover, different virtual consensus instances can operate concurrently, scale gracefully and provide better utilization of resources. Unlike private blockchains, virtual consensus instances enjoy the security, resilience, decentralization and compliance benefits of the underlying shared infrastructure.

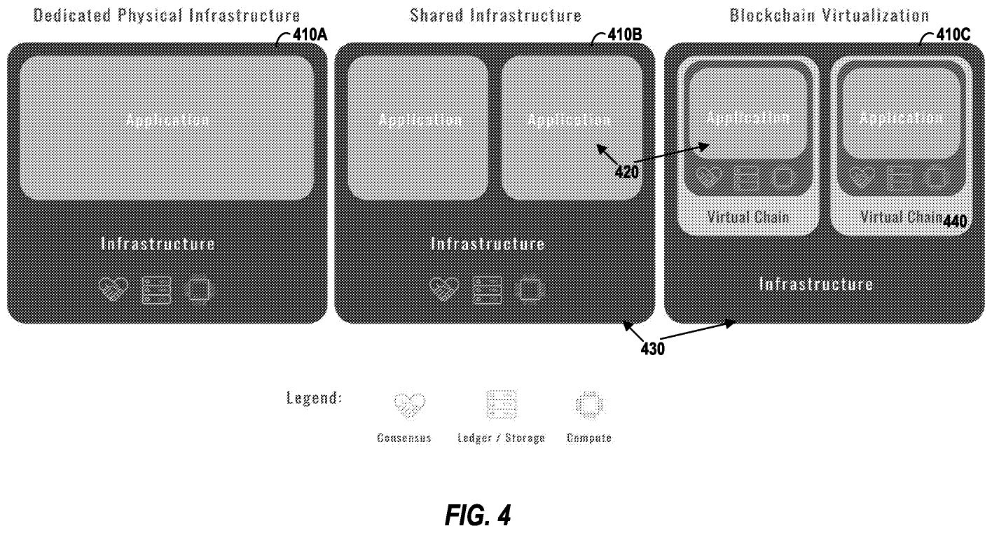

Various aspects of the described infrastructure are depicted in FIG. 4, such as:

Dedicated physical infrastructure 410A—First generation (e.g., Bitcoin). Each application 420 runs over dedicated infrastructure 430 and has its own separate blockchain.

Shared infrastructure 410B—Second generation (e.g., Ethereum). Multiple applications 420 run on top of shared infrastructure 430. The consensus, storage and compute services are shared across applications without isolation or SLA commitments.

Blockchain virtualization 410C—Third generation (e.g., the disclosed platform and related technologies). Each dominant application 420 runs on a separate virtual blockchain 440, relying on virtual instances of the consensus, storage and compute services, but sharing the same physical infrastructure 430.

Blockchain virtualization addresses some of the challenges that decentralized applications face and provides properties comparable to operation over centralized IaaS or cloud platforms. Among the features of the disclosed technologies are:

Service Level Agreement (SLA)—Each virtual chain can guarantee an SLA that meets its needs. Adhering to an SLA is a commitment to reduce the performance impact of other applications that share the same physical infrastructure.

Isolation—The separation of block storage and state of each virtual chain creates isolation from faults and errors that occur on other chains. For example, a bug in an applications smart contract may lead the virtual chain to fork but will not impact other virtual chains on the network.

Sharding and scalability—Virtualization enables inherent sharding of the consensus, and a first level of sharding for compute services and state storage. As there is no synchronization dependency among different virtual chains, their consensus and storage can be handled separately and run concurrently.

Governance—While some configuration parameters may align across all virtual chains, many can be controlled independently. This allows every virtual chain to optimize and cater to its application's needs and reduces governance conflicts between stakeholders.

Elastic capacity—Separation between physical and virtual resources allows a virtual chain to add resources on demand in order to meet evolving usage patterns. Moreover, elastic capacity allows temporary allocation of resources during unexpected bursts.

Security and decentralization—While virtual chains can be dedicated to a single application, the multitude of physical nodes operated by independent organizations and applications are used in practice to process its consensus, capitalizing on the security in decentralization.

Cross virtual chain smart contracts—While isolation is important for transactions within an application or virtual chain, simple cross-chain interoperability proves useful. This can requires synchronization of all involved chains. Such operations are slower and require more resources than a standard operation.

Throughput and Latency—One challenge when designing a blockchain infrastructure for consumer scale is meeting consumer expectations regarding throughput and latency. Successful consumer products have the potential to reach millions of end users performing billions of interactions. This massive scale regularly pushes traditional centralized infrastructure to its limit, making the challenge for consensus-based decentralized infrastructure that much greater.

Throughput is defined as the number of messages per second the network can accommodate. In the field of blockchain, this number can reflect the number of transactions per second that the network can confirm. Traditional blockchain implementations, (e.g., Ethereum) can confirm about a dozen transactions per second. The gap is significant, but this isn't surprising since decentralization comes at a price. First, transactions over blockchain are notoriously difficult to parallelize since the result of one transaction may depend on another. Performing transactions synchronously adds a significant constraint and makes the implementation much harder to scale out. Second, contrary to centralized systems, the consensus process involves a number of independent nodes that must reach agreement over every transaction. This process incurs significant overhead that centralized systems are not required to deal with.

Latency is defined as the amount of time it takes to process a single message over the network. In the field of blockchain, the number often perceived by users is confirmation time. If, for instance, a streaming video service was a consumer product on the blockchain, then a request to stream a video must be confirmed immediately so that the user would not have to wait to start enjoying the video. Existing blockchain implementations (e.g., Ethereum), take dozens of seconds to confirm a transaction. This number often grows to minutes or even hours when the network becomes congested. The gap here is not surprising as well. First, performing transactions synchronously means a transaction must wait in line and will only be processed once every previous transaction has been processed. Second, the consensus process between a group of independent nodes usually requires several roundtrips and is constrained by propagation time of the network which increases as more nodes participate. Third, in some consensus algorithms long block intervals are essential for security, and in models that rely on eventual consensus, actual confirmation is only reached when an arbitrary number of subsequent blocks are generated.

Failure to meet consumer expectations in both of these regards threatens the very success of the product. Consumers are notorious for having low tolerance for bad user experience. Their expectations are determined by the experience they are used to get from current, centralized applications. It is reasonable to expect that most consumers will not be aware of whether the application they use is decentralized or not.

Scalable Fee Models—Scalability of a system goes beyond raw network parameters like throughput and latency. A barrier to scaling a consumer application when launching on Ethereum is infrastructure fees.

One solution is to reduce infrastructure fees dramatically. The high costs of Ethereum are closely linked to its reliance on PoW consensus; in PoW, the operation costs grow proportionally to the total value of assets on the network. As the value grows, the process becomes more wasteful to maintain the proportion. In addition, the number of nodes in the Ethereum network that validate every transaction is more than 20,000, orders of magnitude more than reasonably required in a distributed system. Both of these cost factors can be eliminated by moving away from PoW and using committees to reduce the number of participants in consensus.

Additionally, network usage peaks may cause fees to spiral out of control. For instance, market pricing can lead to volatility and cause entire apps to experience outages. Consider two popular consumer apps with millions of users running side by side when the network is at over capacity. Once the first app modifies its client and increases the transaction fee bid over the other, at one instant its millions of users will have precedence over those of the other app, causing an overwhelming outage for that app. Using the disclosed platform, app developers can purchase reserved capacity in advance, protecting themselves from price fluctuations; they can procure dedicated resources, isolating themselves from peaks in demand; and they can use monthly subscriptions, reducing the overall exposure to price volatility.

Another fee related decision that takes a significant toll over scalability is charging fees per transaction—the common approach taken by other blockchains (e.g., Ethereum). This imposes a large overhead on the network operation. Processing of each transaction requires writing to the native token's ledger, making transactions harder to shard (since even unrelated contracts need to be synchronized). In addition, per-transaction billing adds an overhead in processing and storage, when compared with bulk subscriptions.

Other fee models that can reduce per transaction costs include minimum balance per wallet (e.g., as used in Stellar). The system is designed to provide the necessary friction to reduce spam and fake transaction abuse. Once a user has proven to the platform that their wallet is indeed “real”, by placing a certain number of tokens in this wallet in this case, the platform lifts usage limitations and allows the user to place a large number of transactions from this wallet for a negligible fee. However, such approaches entail drawbacks including consumer commitment hesitation to In certain scenarios, the providers of the decentralized apps may attempt to subsidize these fees to attract customers. Once these fees are subsidized by a 3rd party, they lose their edge in countering Sybil attacks. Even worse, they create a new target for Sybil attacks, enabling attackers to pocket the subsidy in addition to any other gains. By enabling subscription payments as alternative to per-transaction fees, the disclosed technologies limit the bounty one can find in such Sybil attack, and the costs can only be laid on the digital service—who is the only party in power to mitigate such attacks.

Ever Growing Storage—Existing blockchain platforms face challenges due to the fact that resources often scale without correlation to actual technical requirements. For example, on Ethereum there may be as many full copies of the blockchain storage as the number of full nodes, and about as many processors running every piece of smart contract code. While distributed and decentralized systems do require a certain level of redundancy in both execution and storage, the proper redundancy for them would likely be constant, and probably not more than a dozen or two. Though fees are only paid to the solver of the PoW puzzle, all miners expect the mining operation to be cash-flow positive, so in equilibrium the fees would offset the total costs for all miners. The described architecture assures redundancy of any component is within determined bounds.

Storage is a cost generator in another sense. The described technologies provide storage APIs natively define expiration for data, as well as explicit expiration blockchain history. This ensures that data has a defined (rather than infinite) time to live, and greatly reduces storage costs to a magnitude expected in cloud services. In addition, relying on consensus that provides finality allows the described technologies to maintain the state under consensus and removes the need for high bandwidth access to block storage.

Light Clients—As described herein, in certain implementations consumers can access the described network via mobile apps and websites. These usage patterns are characterized by low availability of resources, thus requiring a thin client implementation (a “light client”). In certain implementations, these clients do not synchronize over the entire blockchain history like a full fledged node and usually must maintain some relationship of trust with the node serving them as gateway.

The need to trust a gateway node creates a dependency of the client on the node's honest behavior and enables vulnerabilities such as man in the middle attacks. In order to mitigate the risks, some clients perform a partial validation of the state by validating block headers. Another common strategy is validating data by querying multiple nodes (which may not scale well). The problem is even more significant when a client needs to query a smart contract (which can require the client to trust a node that runs this smart contract on its behalf).

Accordingly, to scale decentralized consumer applications, in certain implementations the described technologies can provide light clients that can operate without trusting a gateway node. This capability is provided over the disclosed platform, e.g., using network owned secrets. For example, the client can provide the smart contract address and arguments to a gateway node, which performs the query and returns a signed response. The light client can validate the signature of the network as a whole, thus reducing the level of trust needed from the specific gateway. An additional aspect of the described technologies that reduces the need for a light client to trust a node is that the protocol guarantees fairness in transaction ordering. By transmitting encrypted pre-consensus transactions, that are opaque to consensus nodes, the described technologies can ensure that transactions are be ordered for execution without censorship or bias.

Separation of Ordering and Validation—The disclosed platform utilizes multiple strategies to increase scalability by several orders of magnitude in order to meet the requirements of mass market consumer apps. Beyond a consensus approach that favors professional nodes that are incentivized towards maintaining high SLAs regarding connection speed, uptime and processing power, several other strategies are incorporated into the platform, including separating consensus ordering and validation.

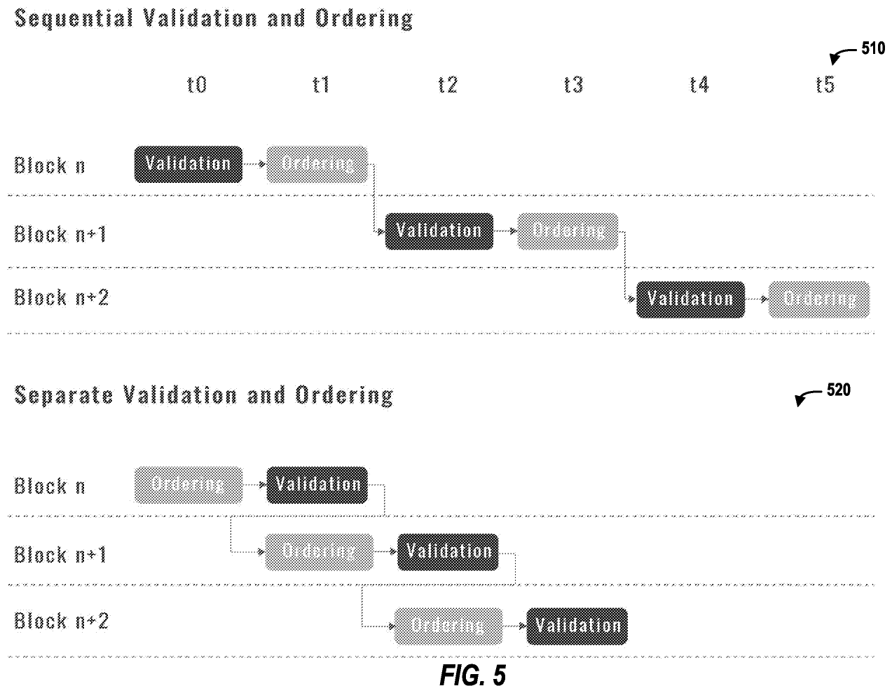

The validation process of smart contracts is expensive and incurs duplicate computational cost since it runs over multiple nodes. When validation and ordering are performed sequentially (e.g., as depicted in 510 of FIG. 5), transaction throughput is limited by the overall time required for the completion of both. Separating the two (e.g., as shown in 520 of FIG. 5) creates a pipeline, thus increasing overall throughput.

Additionally, validation of ordered transactions is an easier problem which permits simpler schemes for concurrent computation and also allows the amount for consensus nodes required for validation to be reduced (improving resource utilization).

Many existing blockchain implementations perform validation and ordering sequentially. Nodes execute all transactions first to validate their output and only then propose a block comprised entirely of valid transactions. Separation techniques enable a transaction to first be sent to a group of endorsers that execute it and return proposed responses. When enough endorser responses are collected, the transaction is forwarded to the consensus ordering service. Performing validation before ordering can be effective for some applications but for consumer applications it can be advantageous to perform ordering first on encrypted transactions (e.g., to guarantee fairness).

Efficient Consensus via Committees—Another approach used by the disclosed platform to increase scalability involves reducing the number of nodes directly participating in the consensus process. This is advantageous since in most consensus algorithms, message complexity grows quadratically with the number of nodes.

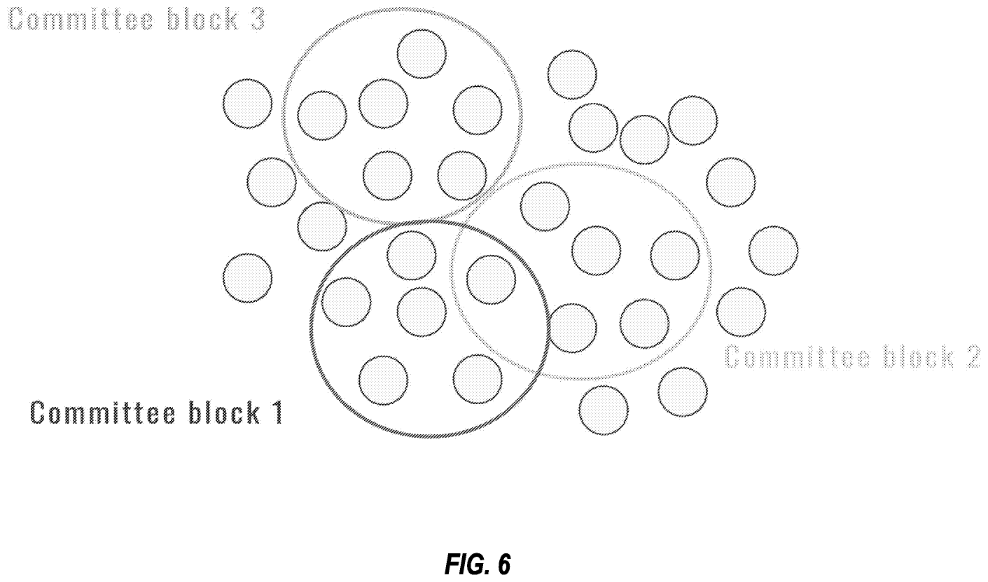

An efficient method for reducing dependency on the total number of nodes is relying on smaller committees for consensus. Randomizing committee members between consensus rounds, e.g. on every new block, can prevent an attacker from knowing which nodes to attack. The randomization process can fulfill several properties to make sure membership cannot be manipulated in advance (to ensure security of the model). Further aspects of the process are depicted in FIG. 6 and discussed in detail in conjunction with the disclosed consensus algorithm/technologies.

Sharding via Blockchain Virtualization—Scaling systems cannot always be achieved by adding more resources, due to bottlenecks that cannot grow easily. “Sharding” is a technique for scaling up systems by dividing them to smaller parts (shards), each small enough to work well despite bottlenecks. Decentralized consensus is an unavoidable bottleneck; the disclosed technologies decouples tenants to different shards allowing the network to scale out horizontally as new tenant apps are added. Unlike centralized infrastructure solutions, adding more resources is usually not enough to increase capacity. Transactions on Ethereum, for example, even by different contracts, may affect one another and therefore must be performed in sequence. Additionally, the number of verifiers in PoW blockchains is related to the level of security the blockchain enjoys; reducing unit sizes by sharding is reducing the level of security in the same proportion. However, such challenges can be resolved effectively using the described architecture and related technologies. Permissioned consensus models, e.g., when employing consensus committees, do not weaken security properties when sharded. Different decentralized consumer apps can operate independently and work with different unrelated assets (e.g., if fees are paid in bulk and not per transaction). By sharding decentralized apps by default, the described architecture can revolve around parallelization.

The disclosed infrastructure can also support many independent consumer applications running on top it. While the applications are independent from one another by design, when running on top of a shared infrastructure they enjoy the benefits of sharing resources, still allowing for the system to scale up due to sharding the virtual chains.

Blockchain applications utilize resources including consensus cycles, ledger (storage) reads and writes, and compute operations. Consensus on transactions of different virtual chains can run independently (e.g., if there are no ordering dependencies present). As such, consensus of different virtual chains can be sharded and run concurrently on separated resources. As there is no ordering requirement, the ledgers of the virtual chains can also be maintained independently. Compute scheduling requires that dependent transactions will be executed in order. As virtual chains have independent ordering, their compute can be performed in parallel. Moreover, the separation of the state for each virtual chain enables a compute node to maintain only the state of the virtual chains that it handles, thus reducing its required memory resources.

Elastic Capacity—In certain implementations, consumer applications can require increases in transaction rate, accounts and storage. Moreover, as additional applications use the infrastructure, higher resources capacity can be needed. In order to meet future capacity recruitments, there is a need for elastic capacity.

Elastic capacity can require that the architecture enabling the blockchain components (e.g., the consensus, compute, or storage) to scale with the addition of resources. Moreover, on the fly updates in the resource allocation should be performed without an interruption to the decentralized application operation.

In centralized systems, a system administrator can adjust the capacity of an application that requires additional resources (virtual or physical). Decentralized infrastructures need decentralized mechanisms for resource allocation, as well as an incentive mechanism for the nodes to provide the resources that are required by the applications.

Decentralized Sharing of Ledger Security—Decentralized implementations for a ledger are easier to secure because the burden of securing the ledger is shared between multiple independent entities. When there is no centralized ownership or governance, no single entity can control the ledger and jeopardize it if it becomes compromised. In addition, multiple parties can constantly audit the integrity of the ledger and can identify discrepancies from the agreed upon protocol.

In existing PoW platforms (e.g., Bitcoin or Ethereum), in a typical transaction, Alice sends some value to Bob by transmitting a transaction (signed with Alice's private key) in which ownership registration of a certain amount oftoken will be modified on the shared ledger to reflect the transfer. The signed transaction is propagated across the peer-to-peer network and reaches miners who verify its validity, and if valid, include it in a block candidate. Each miner then looks for a solution to the PoW puzzle on the block candidate. Eventually, one miner will solve the puzzle and publish the closed block. Other miners receive the closed block, check its validity, and if valid use it as the previous block for their future block candidates.

To be able to call the validators “transmitters”, one could examine whether they are in control of the virtual currency, which means the validators have sufficient credentials or authority to execute unilaterally or indefinitely prevent transactions for a user. Mallory, a malicious miner, can simply prevent a transaction for users by not including their transactions in the block candidates; however she cannot block it indefinitely because other miners should eventually include it in their blocks. Could she execute a transaction unilaterally? Without Alice's private key, she cannot create a valid proof that they have the authority to move value to Bob. But Mallory can create a block candidate that includes an invalid transaction moving Alice's funds to herself, and with some work can solve the PoW puzzle and get that block closed and published. Miners of future blocks are supposed to validate Mallory's block and disqualify it from being included in the blockchain because it contains an invalid transaction. Note that in both cases, what limits Mallory from wrongdoing is the requirement that an undefined, random group of future miners will confirm her blocks' validity.

In the case of Bitcoin and Ethereum, various properties assure the validators are not in control of the ledger, such as: the cryptographic protocol makes it impossible for validators to send transactions unilaterally, and the openness of the network makes it impossible for validators to indefinitely prevent transactions.

The cryptographic protocol defines what valid transactions are, in a deterministic and universally accepted fashion. This means that if invalid transactions are included in a block, and the network consensus is to accept the block, then this consensus is not following the protocol and in essence it is not a consensus of the Bitcoin or Ethereum network. In other words, if Bitcoin accepts invalid blocks, then it's not Bitcoin anymore.

The openness of the network is enabled by the ability of anyone to join the network as a validator. If Alice suspects her transactions are censored by the network's validators, she may join the network as a validator and approve her own transaction. Because her block is valid, future block validators should include it in their chain (as noted, if they're not following the protocol, it's not the same network).

Censorship and Front-running—Relying on the openness of the protocol for combating censorship of transactions is not ideal in some real-world uses. Though miners cannot indefinitely prevent a user from transacting, a miner closing a block can arbitrarily choose to leave transactions out, delaying them to a future block closed by another miner. This power is significant in the hands of large mining pool leaders.

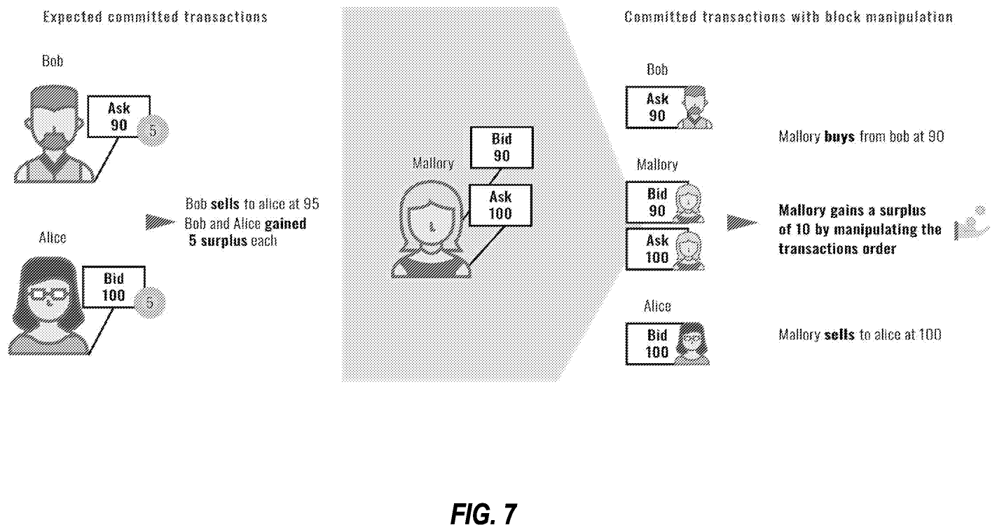

Moreover, miners can choose the order in which transactions are placed in blocks, and even craft transactions that will manipulate them for financial gain. For example, FIG. 7 depicts a scenario in which a smart contract implements a two-sided trading market in which a certain class of assets are traded for a currency. At a certain time, Alice posts a “bid” for an asset, for a maximum price of 100 tokens. Bob posts an “ask” for the same asset, for a minimum price of 90 tokens. Normally, the trading contract will split the spread and commit the trade for 95 tokens, leaving both Bob and Alice with surplus of 5 tokens. But Mallory, the miner who will close the block, can then add two more transactions: prepend Bob's transaction with an “bid” for a maximum price of 90 tokens, and append it with a transaction containing “ask” with a minimum price of 100 tokens. The new sequence of transactions will cause the smart contract to sell Bob's asset to Mallory for 90 tokens and then sell it to Alice for 100, leaving the entire surplus of 10 tokens in her hands.

However, of the described technologies enable the challenge of manipulation by miners to be addresses with more effective tools than openness. For example, a consensus protocol in which validators agree on the order of transactions without knowing their contents ensures that validators don't have knowledge they can use for manipulations (e.g., censorship and front-running).

Further incentivization towards fast resolution of governance questions can be applied through economic means. The node reputation system maintained by the disclosed consensus algorithm and associated technologies allows for simple implementation of incentives, since reputation score controls the voting power of a node in the consensus process and its share of the fees thereafter. It can be advantageous to incentivize nodes to vote quickly on making a new protocol version official. This can be done by reducing the reputation of those who linger. To incentivize nodes to upgrade to the latest version of the protocol which is under consensus, the reputation of those who fail to do so can be reduced (e.g., slowly at first, when new protocol versions are still backwards compatible, and more aggressively when older versions approach end of life). The voting mechanisms for governance purposes in the described platform can be implemented as smart contracts running over the management chain itself.

Another mechanism for reducing friction is providing an outlet for changes that are important only for parts of the network. For example, a modification that pertains to one entity participating in the ecosystem. If this change is unrelated to other entities (or adversely impacts performance for entities who don't need it), its contributor may find it difficult to bring it to consensus. This challenge can be resolved using the described technologies by allowing protocol modifications to apply to a specific virtual chain. In this case, the consumer app requiring the modification can limit its effects to a voluntary configuration that is enabled in the dedicated virtual chain it is renting from other nodes. This eliminates the motivation for other participants to oppose to the change.

Gradual Migrations—Once a core protocol change has been agreed upon, the question of its methodology of deployment remains. Migrating an entire network at once can entail substantial risk, e.g., if unforeseen problems arise after deployment to production.

Many changes can be deployed gradually, enabling the developers and chain administrators to gain confidence in its correctness based on actual performance rather than estimates (reviews, simulations, tests, etc). Using methods such as Blue/Green Deployments, when changes are entering the production system, the entire network clones and directs traffic to both the unchanged (blue) and changed (green) code. Processed traffic can then be considered either live or in testing; essentially every transaction is processed on both environments, but the “live” transactions are committed to the permanent storage and the “test” transactions are only tested to verify that they are correct and maintain a set of predetermined KPIs as compared to the live environment. The deployment process starts with a period in which the entire “green” traffic is in testing, then split 90%-10%, 50%-50% and 0%-100%. Each such change can be approved by its developer or by consensus, after checking performance KPIs of both systems. Another benefit of this methodology is the ability to rollback and return to the blue system in case a major malfunction is discovered.

This gradual process of migration can also be used to migrate from a previous blockchain solution (e.g., Ethereum) to the disclosed technologies in a risk-free manner. Consider a secondary token ‘TOK’ that was originally launched on top of the Ethereum blockchain and TOK now wishes to migrate from Ethereum to the disclosed technologies/platform. In lieu of a full migration all at once, the TOK client SDK used by consumer apps that support the token can start mirroring all transactions performed by end users to the disclosed platform in parallel to Ethereum. All writes can take place to both blockchains, creating a duplicate ledger for TOK on top of the disclosed platform. This ledger can be constantly audited and compared to the Ethereum ledger which is considered the source of truth. Initially, TOK clients perform business decisions based on the Ethereum reads, but this can be changed per user with a runtime feature toggle. To start the migration, this feature toggle is switched for 5% of users. If everything operates successfully, this can be increased to 50% and finally 100%. If a problem is discovered, the feature toggle can be switched back and all users will return to making their business decisions based on Ethereum. Since all writes are duplicated, there is no risk of losing the ability to rollback.

Upgradable Contracts—Once deployed, smart contracts are immutable in nature and cannot be updated. Although this behavior is a feature of smart contracts, immutability poses practical concerns, e.g., in scenarios in which the smart contracts includes undiscovered mistakes or ‘bugs.’

In certain implementations, just as questions of protocol updates can be resolved using consensus (e.g., once a majority of parties agrees to upgrade the protocol to a new version) the upgrade of smart contacts can be resolved in a similar fashion. Smart contracts executing on the disclosed platform can be encouraged to employ an upgrade strategy. This strategy can be implemented as another smart contact and controls the process through which the contract can be upgraded. Contracts for secondary tokens can elect to upgrade based on a stake-weighted vote of all holders of the token.

Multi Chain Hybrids—Various decentralized applications may require solutions based on multiple blockchain infrastructures running side by side, which can pose various challenges. For example, launching a token on Ethereum can provide numerous advantages (large ecosystem, etc.) as well as significant disadvantages (limitations on transaction scale due to high fees, network congestion, low transaction throughput, etc.). These drawbacks can cause projects running on Ethereum to consider a migration of the tokens to another blockchain infrastructure.

However, performing a one-way migration can jeopardize the ability of some parties to integrate with the token. Instead, it may be advantageous to base the token on a hybrid solution of two blockchains. The first blockchain can be Ethereum (e.g., on account of its extensive ecosystem of integrations) while the second blockchain can be a scalable solution as described herein. These would be two different implementations of the same token. Users can be enabled to perform a 1:1 swap of tokens between the two implementations and the total amount of circulating tokens on both implementations can equal the original number of tokens created (e.g., during the referenced ICO).

Polyglot Cross-Chain Contracts—with the described hybrid solutions (which rely on multiple different blockchains at the same time)—can introduce additional challenges, e.g., with respect to the combination of different blockchains and communicate between them.

Existing smart contracts (e.g., in Ethereum) may be limited in their ability to access external sources and may only rely on data existing on the blockchain itself as opposed to external data (e.g. as provided by an entity referred to as an ‘oracle’).

The disclosed platform overcomes this inherent limitation of smart contracts via cross-chain contracts. These cross-chain contracts can be smart contracts running on top of the disclosed platform that are configured to read data from other blockchains in a secure and trusted way. Being that a smart contract can read variables from secure on-chain storage, the described smart contract (cross chain contract) can also read a variable from Ethereum. This functionality can enable new types of decentralized applications. For example, applications can span multiple blockchains and select the most appropriate one to hold different pieces of its data. Additionally, the described functionality can enable smart contracts originally developed for other blockchains to be seamlessly imported directly into the disclosed platform. Accordingly, the disclosed platform can support the execution of smart contracts written in multiple languages. Such smart contract languages can include but are not limited to: Ethereum Solidity, Python, Java JavaScript, etc.

In certain implementations, the described consumer applications are accessed by users via mobile and web clients. in certain implementations, such mobile/web clients can be implemented as light clients which connect to one or more full nodes through which they can query to read blockchain data or send transactions through. In certain implementations, such users may expect to have a certain degree of trust with the nodes they connect to. The described technologies provide technologies such as Opaque Pre-Consensus Transactions and Network Owned Secrets to simplify the light client protocol and can significantly reduce the required level of trust.

Consumer Patterns of Network Access—Consumers may also demonstrate patterns of network access that may influence infrastructure design. Consumers are likely to access a single account from multiple devices concurrently (e.g., using a mobile phone, laptop, tablet, etc. to access the same app in different locations/circumstances).

Certain design decisions on the infrastructure layer can make the platform incompatible with such patterns. Consider the use of nonce in transactions on Ethereum. The purpose of the nonce is to assure uniqueness of a transaction and make sure the network does not process the same transaction twice. Ethereum clients put sequential numbering in the nonce field that increments on every transaction sent from an account. Ethereum relies on this numbering and will not process a transaction until its predecessor is confirmed. This mechanism is not suited for use by multiple devices concurrently, as the sequence numbering needs to be synchronized across devices. This complication is avoided in the disclosed technologies by using a non-sequential mechanism to add uniqueness to transactions.

Another common access pattern by consumers is the transmission of multiple requests in parallel instead of one after the other. Consider a peer-to-peer advertising platform where a group chat user shares an advertisement with the entire group. If the user needs to reward all group members for receiving the content, they would likely transmit multiple transactions in parallel. On Ethereum, confirmation time for each transaction can take 15 seconds. How is the nonce calculated in this case? A standard implementation would be to increment the nonce on the client-side and send all transactions in parallel with sequential nonce numbers. Now, assume that one of the transactions failed for some reason. The platform would not process the subsequent transactions because a transaction having the first free nonce was not confirmed. This edge condition is once again avoided in the disclosed platform by using a non-sequential mechanism to add uniqueness to transactions.

Infrastructure Implications of Churn—Churn, short for churn rate, is a measure of the number of individuals or items moving out of a collective group over a specific period. In consumer applications, churn refers to the proportion of end users who leave and stop using the product during a given time period. For decentralized apps that involve a token that consumers use, churn can dictate how distribution behaves over time. As the number of users lost to churn increases, so does the number of tokens left inaccessible inside the wallets that they possessed. Since the supply of such tokens may be limited, a substantial portion of tokens may end up out of circulation. Additionally, certain token economies may utilize subsidies distributed to groups of consumers in order to initiate use of the token. However, such subsidies may end up in the hands of users who will never use it. Accordingly, in certain implementations the described technologies can enable the design of a token protocol layer that effectively deals with such challenges. For example, a token smart contract can allow recycling of introductory subsidies, e.g., in scenarios in which the wallet was not used in the 12 months following the subsidy, thereby eliminating the problem of churn.

In certain implementations, the disclosed platform and network can be implemented as a community of ecosystem partners, made up of organizations, entities, etc. that can be aligned as independent but equal members of a federation. Such members can assume roles in the described federation including: operating consensus nodes in the network and actively participating in the consensus process, providing decentralized governance for the platform such as reaching consensus over core updates to the protocol, etc.

In certain implementations, access to a cryptocurrency wallet can be synonymous with knowing a single secret—the wallet's private key. This key can be immutable and cannot be recovered if lost. In order to protect the wallet against attempts to guess the key with brute force, a high degree of entropy is commonly used (Bitcoin wallets, for example, use keys with a length of 256 bit). Safeguarding such private keys from being stolen or lost can be difficult, particularly for consumers who may lack the resources/knowledge to securely maintain such strong cryptographic keys and do only moderately well with simple authentication methods, such as passwords, PIN codes, recovery questions, biometrics etc. Such simple authentications alone are often not secure enough for protecting valuable assets, such as identities or large amounts of funds, and are often used as part of a authentication protocols that include “real world” actions such as delays, fallback between different authentication challenges (for example, try PIN code, or fall back to security questions), multi-factor authentication, access notifications, timelocks, etc. Existing technologies only enable such protocols to be executed on centralized repositories (e.g., a bank's computer system can enforce a delay between failed PIN code entry attempts). However, existing decentralized blockchains cannot effectively enable such authentication protocols.

Accordingly, as described herein, the disclosed platform and related technologies enable decentralized secret bearing. As described herein, the disclosed platform can be configured to store and use secrets (e.g., secret cryptographic keys). This is done, for example, via protocols that utilize techniques including secret sharing and threshold cryptography, thereby enabling operations like signing or decrypting a document with the decentrally-stored key. This functionality can be advantageously implemented in multiple contexts, such as: signing a blockchain's state with a single canonical signature, signing transactions to be executed on other blockchains, notarizing the state of other (connected) blockchains, signing API calls for third-party infrastructure, etc.

By way of illustration, the described technologies can enable the described decentralized secret bearing to save cryptographically-strong private keys in a decentralized manner, and further by enforcing a secure authentication protocol which can include delays, multi-factor authentication and other methods—on a decentralized platform.

As described herein, the described technologies provide decentralized management of strong cryptographic keys (e.g., for users/consumers) based on lower-strength user authentication (such as PINS, passwords, etc.). In certain implementations, the described technologies provide such functionality based on a network of nodes, some of which may be non-trusted or compromised. The network may be decentralized with no single entity in control of its nodes.

Having key management and authentication performed by multiple nodes (which may run under different management and/or having different system architectures and platforms) can provide significant advantages with respect to resistance to hacking/intrusion by having no single point of failure.

For example, as described herein, various applications and services (e.g., consumer applications, such as are described herein) store and/or require access to valuable and/or sensitive data such as, banking information, medical records and credit card information. In order to keep such sensitive data secure, such applications/services often store such sensitive data in an encrypted format. Cryptography is utilized in many settings and contexts in order to verify the authenticity of identities, authorizations, documents, etc.

As consumer use of digital technologies continues to increase, consumer products, applications, services, etc. (e.g., for banking, payments, file sharing, cloud back-ups, gaming, etc.) also increasingly depend on highly secure cryptography. However, existing secure cryptographic techniques are often inconvenient or impractical or for many mass-market users/consumers. Such difficulties are further evident in decentralized applications (e.g., blockchain-based applications, services, etc.), where there may be no operator capable of providing user support or incident response. With such decentralized application, there is no “central management” overseeing a highly secured central private key storage.

Effective cryptography can depend on the use of strong cryptographic keys. To ensure security, such keys should be managed securely, particularly as the number of applications, systems, services, etc., used by a given consumer/user increases, with each application, etc. requiring its own (strong) key. However, as noted, existing secure key management procedures/techniques are often impractical or inconvenient for many users/entities. Such users may be accustomed to simple authentication methods (e.g., passwords, PIN codes, recovery questions, biometrics etc.), though such simple authentications alone may not be secure for protecting valuable assets (e.g., as the identity of the user, substantial funds, etc.). The inexperience of such consumers in managing strong keys in a decentralized environment can expose such users to significant risk/loss, e.g., in the case of users who fail to preserve their cryptocurrency wallet private keys and subsequently lost significant amounts of crypto currency.

Various information-theory techniques/concepts can be used to measure the level of protection a credential provides, e.g., by estimating the number of entropy bits they provide. For example, if a password with a strength of 30-bits (about 9 decimal digits) can be cracked by a certain computer in one second, a password with a strength of 40 bits (between 8-9 English letters) will require about 17 minutes to crack, and a 128-bit private key will require about ten sextillion (10²²) years.

To increase the security of an authentication system that utilizes low-entropy credentials (short or weak passwords, PIN codes, hashed biometric data, password recovery questions, etc.) an authentication protocol (‘AP’) can be designed/configured to limit (e.g., throttle) the access ability of an attacker (e.g., an entity attempting to fraudulently authenticate) without limiting authentic user's access. For example, an authentication protocol can employ techniques such as delays (e.g., preventing further authentication attempts for a defined chronological interval after a certain number of authentication failures), fallback between different authentication challenges (for example, prompting for a security question after failure to authenticate via PIN code,), multi-factor authentication, access notifications (e.g., transmitting a message to the user reflecting that several unsuccessful authentication attempts have been made), timelocks, etc.

In certain implementations, the described technologies can be implemented with respect to user authentication in cryptographic applications/systems. Such user authentication can be implemented or utilized with respect to various operations, such as private key management and transaction or document signing. However, it should be understood that the described technologies can be advantageously implemented in any number of additional contexts, settings, applications, etc.

It can be appreciated that authentic users may exhibit various behaviors, actions, etc. (in contrast to fraudulent users attempting to falsely authenticate using the credentials of another user). For example, such authentic users may try to type their password a handful of times (but not millions of times). Such authentic users may also easily shift between authentication methods (e.g., between passwords and recovery questions). Such authentic users may also be capable of authenticating on multiple factors of authentication (e.g., knowledge, possession and inherence) simultaneously.

Accordingly, a complex authentication protocol can, for example, utilize various techniques (and/or a combination thereof) to provide a high level of protection, e.g., with respect to user authentication. Such techniques can include but are not limited to:

Locking authentication elements, e.g., by making them unavailable (e.g., time-limited) when accessed repeatedly.

Requiring multiple factors of authentication to be provided.

Shifting between authentication techniques.

Notifying the user (e.g. by phone, SMS text message, email, etc.) of an access attempt.

Prompting the user (e.g. via SMS, instant messenger, text message, or e-mail) and requiring specific response/confirmation (e.g., selecting an e-mailed confirmation link or entering an additional generated authentication code).

Selectively applying parts of the authentication protocol based on the operation the client wants to perform.

Additionally, in certain implementations the described authentication protocol may include operations that involve services outside the authentication system, such as: sending a report to a logging system, notifying a third party (e.g., a system operator or security personnel) of an authentication attempt, locking out a non-authentication resource (e.g., a social network account), etc.

It can be appreciated that the security of an authentication protocol can be increased as contact with the user is established through multiple channels (e.g. through an Internet data/communication session and the parallel SMS text message channel).

Existing systems employ various authentication protocols by utilizing a centralized operator that secures the authentication data and applies strong enforcement of the authentication protocol rules. Such systems utilize centralized storage and management of multiple elements of authentication, including the authentication protocol definition, the various weak (low-entropy) keys and the resulting strong keys, each of which are stored in a centralized manner. Though the system's storage itself may be distributed over multiple locations (e.g. to allow key-based operations to continue in the case of service disruption affecting certain data centers), the system still operates in a manner, forming an inherent single point of failure.

The centralization present in existing systems requires a user to trust the management of the centralized operation to maintain the security of his/her keys. However, even large, well-funded and technically-savvy organizations can fail in this respect and suffer substantial data breaches. Well-designed systems can still be susceptible to insider threat—e.g., being breached by an employee or individual having access permission to the appropriate data.

Accordingly, as described herein, the disclosed technologies can include systems and related technologies that provide a protocol of simple authentications in decentralized and/or partially-trusted environments. In certain implementations, the described technologies can utilize the described authentication protocol to retrieve a secret, or used to perform cryptographic operations without retrieving it.

The described technologies can be implemented in various settings, contexts, etc. For example, the described technologies can be implemented with respect to key storage. In certain implementations, the described technologies can be configured to secure or safeguard a strong private key on behalf of a user/entity. Such a user can authenticate/identify him/herself via an authentication protocol that utilizes various weak key authentication operation(s) (e.g., by requesting a PIN code, biometric authentication, etc., from the user). If the authentication is successful, the strong key is delivered to the user. Alternatively, in certain implementations the described technologies can be configured to maintain the referenced strong key within the network (and thus not provide the actual key to the user). Rather, the user can utilize the described authentication protocol to direct/instruct the node(s) to perform various operations with the referenced strong key, such as using it to access another system, allow physical entry to an area.

By way of further example, the described technologies can be implemented with respect to document/content signing (e.g., signing a document or other content with a strong key). In such a scenario, multiple nodes of the described system can utilize the described authentication protocol to cooperate in signing, or otherwise verifying a transaction, commitment, document, etc. provided by the user with a strong key (e.g., without revealing the strong key to the user). Alternatively, in certain implementations the signed document can be provided/forwarded to another (e.g., without providing a signed copy to the user, such as in a transaction in which the intended recipient of the signed document does not want the user to have a signed copy). In yet another implementation, the described signing procedure can be applied to a hash of the referenced document (such that the various system nodes do not have access to the original document).

By way of further example, the described technologies can be implemented with respect to access control, e.g., for the decentralized system itself. In such a scenario, the described authentication protocol can utilize validation of one or more weak key(s) as means to approve a transaction or operation within the decentralized system, issue an access token, etc., as described herein.

The referenced authentication protocol can be include, for example, a defined series of authentication steps and may be defined using a full Turing-equivalent language, e.g., in a programming language, a smart contract language, specific language, etc.

In certain implementations, the referenced authentication protocol language can support time-dependent operations and events. In doing so, time-dependent operations such as “block access for one day if password was incorrectly entered three times” or “timeout after three minutes if the user didn't respond to a specific biometric challenge”. Such operations can be advantageous ino preventing a brute-force attack (in which multiple authentication attempts are made in rapid succession).

The described authentication protocol can execute across/in relation to multiple nodes in a decentralized network. In certain implementations, the authentication protocol can be an application, program, etc. executing on one or more node(s), machine(s), device(s), etc. with associated storage (with the machine including support for timer/clock operations). One or more nodes within the network can execute a step/operation in the authentication protocol and can also determine the next step to execute (thereby supporting program branches) and/or changes to make to the storage associated with the machine. In certain scenarios, various nodes may conflict or disagree as to the next step selection and the changes to the storage. In such scenarios, and the actions taken can be determined based on consensus achieved among the nodes running the authentication protocol (e.g., using a decentralized consensus algorithm, as described herein).

As described in detail herein, the disclosed system can be configured to utilize a complex protocol of authentications (e.g., weak authentications), e.g., with respect to a user, to provide or enable access to a strong cryptographic key. The described strong key can also be referenced or referred to herein as a signature (e.g., in the described scenarios in which the authentication protocol is used to sign documents or transactions) or a secret. Additionally, in certain implementations, such a secret or strong key can be broken or divided into shares, portions, or other such segments. Such shares can be combined to form the secret, e.g., using one or more [t,n] threshold secret sharing techniques such as the Shamir or Blakley schemes.

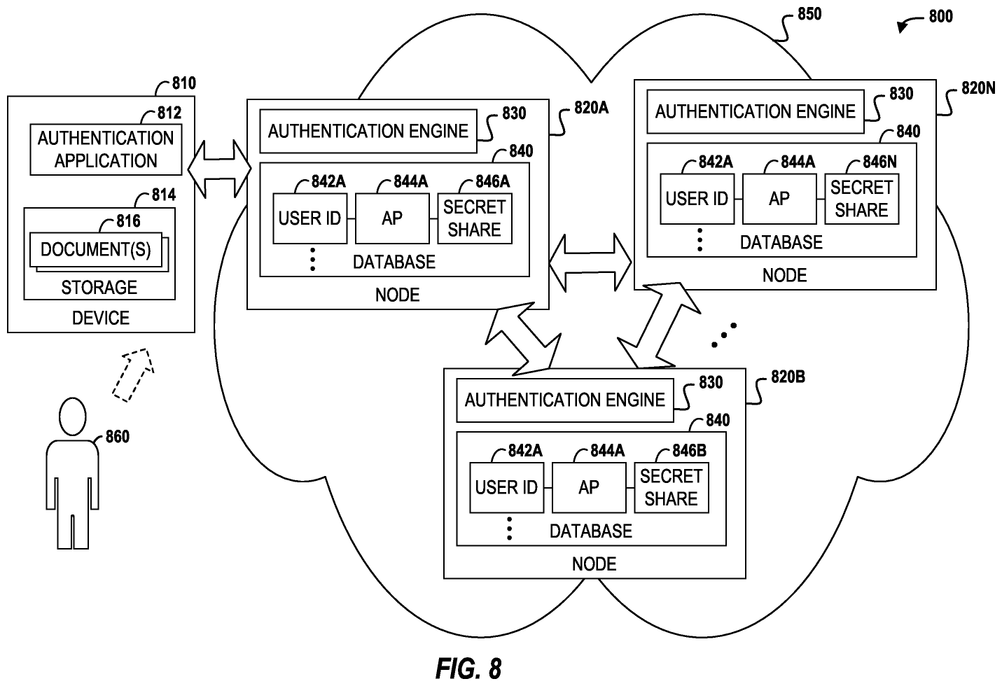

FIG. 8 illustrates an example system 800, in accordance with some implementations. As shown, the system 800 includes components such as device 810. Device 810 can include a laptop computer, a desktop computer, a terminal, a mobile phone, a tablet computer, a smart watch, a wearable device, a personal digital assistant (PDA), a digital music player, a connected device, a speaker device, a server, and the like. User 860 can be a human user who interacts with device(s) 810. For example, user 860 can provide various inputs (e.g., via an input device/interface such as a keyboard, mouse, touchscreen, microphone, etc.) to device 810. Device(s) 810 can also display, project, and/or otherwise provide content to user 860 (e.g., via output components such as a screen, speaker, etc.).

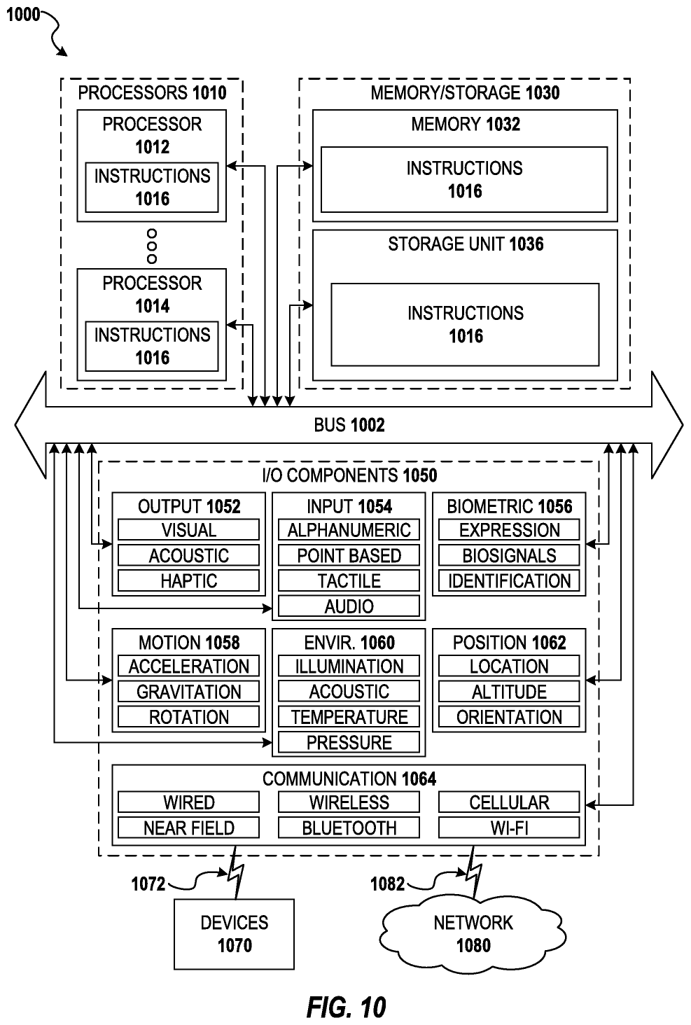

As shown in FIG. 8, device(s) 810 can include one or more applications such as authentication application 812. Such an application can be a program, module, or other executable instructions that configure/enable the device to interact with, provide content to, and/or otherwise perform operations on behalf of user 860, e.g., in order to initiate and/or execute various authentication operations as described in detail herein. Such application(s) can be stored in memory of device 810 (e.g. memory 1030 as depicted in FIG. 10 and described below). One or more processor(s) of device 810 (e.g., processors 1010 as depicted in FIG. 10 and described below) can execute such application(s). In doing so, device 810 can be configured to perform various operations, present content to user 860, etc., as described herein.

In certain implementations, device 810 can also include storage 814. Storage 814 can be, for example, a hardware component (e.g., memory) or a software application configured to store document(s) 816 and/or other information, content, etc., as described in detail herein.

It should be noted that while application 812 and storage 814 are depicted and/or described as operating on a device 810, this is only for the sake of clarity. However, in other implementations such elements can also be implemented on other devices/machines. For example, in lieu of executing locally at device 810, aspects of the referenced application(s) can be implemented remotely (e.g., on a server device or within a cloud service or framework).

As also shown in FIG. 8, device 110 can connect to and/or otherwise communicate with network 850 and/or various nodes 820A-820N (collectively, nodes 820) that make up such a network (e.g., a decentralized or distributed network). Connections between the various devices/machines can be initiated and/or maintained via various networks such as the Internet, a wide area network (WAN), a local area network (LAN), a virtual private network (VPN), an intranet, and the like.

Each of the referenced nodes 820 can be, for example, a server computer, computing device, storage service (e.g., a ‘cloud’ service), etc. and can include authentication engine 830 and database 840. Authentication engine 830 can be an application that configures/enables the node to implement various authentication protocols, e.g., as described in detail herein. Database 840 can be a storage resource such as an object-oriented database, a relational database, a non-relational database (e.g., NoSQL) that stores various information pertaining to the referenced authentication protocols, as described herein.

As noted, the described system can include a collection of nodes 820 (e.g., servers or other such computing devices capable of performing the described operation(s)). Each of the referenced nodes can include or incorporate a database 840 or other such content repository. In certain implementations, such a database can map hashed usernames 842 (e.g., corresponding to a user) to a share of their secret/strong key 846, together with the access protocol 844 to be applied to accessing such a secret/key. In certain implementations, each respective node may store the shares of multiple secrets/strong keys for multiple users.

In certain implementations, the operator of a node can be responsible for securing the local secret shares (e.g., by maintaining an encrypted copy of it on unprotected hardware and performing the cryptographic operations on it on a hardware security module that decrypts the share and performs the required operation in a secure environment). It should be understood, however, that even in a scenario in which the security of multiple nodes was compromised, the underlying secrets are still secured as long as a sufficient minority of the nodes remain secured (i.e., the compromised nodes together do not exceed the required encryption threshold t).

As described herein, the referenced authentication protocol performs operation(s) based on a set of weak keys. Such weak keys can be stored or secured in a number of ways. For example, in certain implementations the information required to negotiate a zero-knowledge proof that the user knows the weak key can be stored. Such information may be generated or otherwise derived from a weak key (e.g., a password), but cannot be used to reconstruct it.

Additionally, in certain implementations the referenced weak keys (and/or their one-way hash) can be broken or otherwise divided into shares. Respective shares of such weak key(s) can be stored across different nodes in the system. In doing so no single node will contain the full information associated with a particular weak key. In such a scenario, the nodes can be configured to perform additional functionality with respect to validating the weak key(s) in a distributed manner. In doing so, the weak keys are known only to the client and are not known in their entirety by any individual node. Accordingly, situations in which a network node (which may not be trusted) is exposed to a full weak key can be prevented.

In certain implementations, the described system can also implement various secret sharing cheater detection or cheater identification techniques and/or penalty mechanisms for detected cheaters (e.g. blacklisting them from further operations).

In certain implementations, the described system can also include an incentive layer, as described herein. Such an incentive layer can include instructions, parameters, etc. that, when implemented, incentivize participating nodes not to collude to gain knowledge of the users' keys and/or to maintain the security of their secret share. Such an incentive layer may be independent or part of an incentive layer that pertains to other aspects of the system, as described herein. Additionally, in certain implementations such an incentive layer may utilize stake placed or provided by the participating nodes.

The user accesses the system using a client machine/device. In certain implementations, such a client 810 may be part of the node network 850 (and may interact directly with multiple network nodes 820), while in other implementations it may not be (and may access the network via one of the nodes, e.g., a session leader node). In certain scenarios the referenced client machine 810 may be a trusted machine (e.g., to perform strong key storage/retrieval), while in other scenarios (e.g., for document signing, as described herein) such a client may not necessarily be a trusted machine. For example, in various scenarios the referenced client machine can be a device provided by the user (e.g. the user's desktop, laptop, mobile device, etc.) or may be a machine provided to/accessed by the user (e.g., an ATM access terminal).

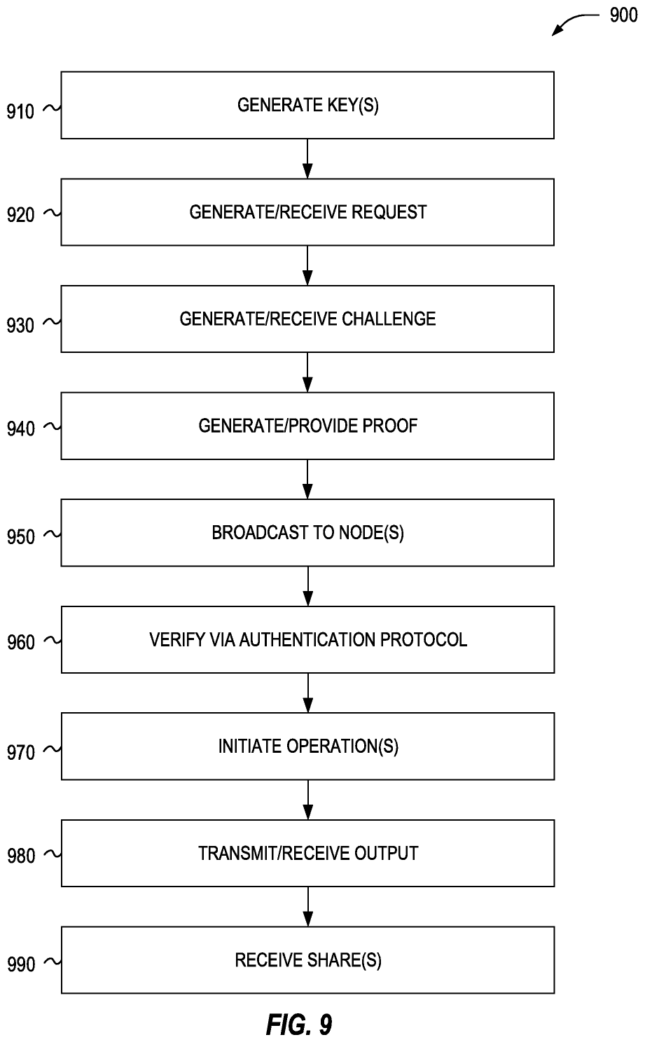

FIG. 9 is a flow chart illustrating a method 900, according to an example embodiment, for decentralized private key management. The method is performed by processing logic that can comprise hardware (circuitry, dedicated logic, etc.), software (such as is run on a computing device such as those described herein), or a combination of both. In one implementation, the method 900 is performed by one or more elements depicted and/or described in relation to FIG. 8 (including but not limited to device 810, authentication application 812, network 850, node(s) 820, and/or authentication engine 830), while in some other implementations, the one or more blocks of FIG. 9 can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 910, an asymmetric key pair (Ts, Tp), can be created/generated, e.g., for single-session use. For example, client device 810 and/or authentication application 812 can generate a public session key and a private session key (e.g., for use in conjunction with an authentication instance and/or other operations, as described herein). Such a key pair can be associated with an instance of authentication of the referenced user.

At operation 920, a request (e.g., an authentication request) can be generated/transmitted (e.g., by client 820) and/or received (e.g., by decentralized network 850 and/or one or more nodes 820). In certain implementations, such a request can be associated with a user identifier (e.g., with respect to user 860). For example, in certain implementations, to initialize an authentication session, the client can connect to the described network 850 directly and/or via a network node (the session leader). Such a session leader can be selected by the system (e.g. using a load balancing arrangement), by the client, and/or may be randomly selected.

In certain implementations, the client initializes a session by sending Tp and the key request (e.g., to the session leader, one or more of the refenced nodes, etc.). Such a key request can include the user ID and/or hash (which may be encrypted) associated with the requesting/authenticating user. Additionally, in scenarios in which the described technologies are utilized to sign a document (e.g., document 816 as stored in storage 814), the referenced document (or its hash) can also be included as part of the referenced request.

At operation 930, an authentication challenge/prompt can be generated/provided (e.g., by one or more of the referenced notes) and/or received (e.g., by the referenced client). In certain implementations, such a challenge can be generated in accordance with an authentication protocol associated with the user identifier (e.g., authentication protocol (AP′) 844A as stored in database 840, which is associated with user ID 842A corresponding to user 860). For example, in certain implementations, the referenced session leader can create a challenge (e.g., requesting a PIN, password, etc., as described herein). Such a challenge can be created, for example, using a deterministic method (e.g., Merkle tree) on the most recent consensual system state (e.g., which is consistent between all nodes).

At operation 940, proof of a possession of an authentication credential is generated (e.g., by the referenced client) and/or provided (e.g., by the client to one or more nodes, e.g., in response to the challenge/prompt received at 930). For example, the client sends a zero-knowledge proof of its possession of the weak authentication credential (e.g., password, PIN code, etc.), signed by Ts. This can be done using a non-interactive zero-knowledge proof protocol, or a zero-knowledge password proof protocol.

At operation 950, the referenced proof (e.g., as generated at 940) and the request (e.g., as generated at 920) can be broadcast (e.g., by the referenced client) to and/or received by one or more of the referenced nodes. For example, the generated proof, Tp and the key request can be broadcast to all or to a selected group of nodes in the system.

At operation 960, one or more of the referenced nodes can verify that the generated proof (e.g., as broadcast/received at 950) conforms to the appropriate authentication protocol. For example, the referenced nodes verify that the client access is in conformance to the authentication protocol, (e.g., using the described inter-node authentication protocol execution consensus described herein).

At operation 970, an authenticated operation can be initiated, as described herein. In certain implementations, such an authenticated operation can be initiated based on verification (e.g., at 960) that that the generated proof conforms to the authentication protocol. Additionally, in certain implementations such an authenticated operation can be initiated with respect to a share of a cryptographic key associated with the user identifier (e.g., secret share 846A as associated with user ID 842A and stored at node 820A). For example, upon successfully verifying the client access is in conformance with the authentication protocol, each node uses its key share to perform various resulting operation(s) (as described in greater detail below and herein).

At operation 980, an encrypted output can be transmitted (e.g., from a respective node) and/or received (e.g., by the client). For example, the response/output of each node can be encrypted with Tp and sent to the client. The session is closed on the node's side.

At operation 990, one or more shares are received (e.g., shares of the secret/cryptographic key associated with the user identifier), e.g., from multiple nodes. In certain implementations, such shares can be decrypted (e.g., at the client) with the referenced private session key (e.g., as generated at operation 910). For example, the client receives/collects a threshold of sent shares, decrypts them with Ts, and acts upon them.

Moreover, in certain implementations, such as when the described technologies are implemented with respect to document signing, if the transaction is public, the client may receive a signed document with the aggregated signatures of the nodes.

In certain implementations, the client can then erase (Ts), thereby closing the described session.

The referenced authentication protocol definition can be maintained in the databases for each node (as it is not a secret by itself). For example, as shown in FIG. 8, the database of each node 820A, 820B, 820N maintains the referenced authentication protocol (AP) 844A. The nodes may maintain multiple authentication protocols for multiple clients and purposes (as the nodes operate as authentication service providers for multiple clients).

In an alternative implementation, the shares for each given secret (e.g. at the secret or user level) can be stored in a specific subset the nodes. In such a scenario, a distributed service discovery mechanism can be included, whereby the client or the session leader can identify a set of relevant nodes. In certain implementations, the system can be configured to require such subset to have a minimal size, or be distributed in a specific manner (e.g., geographically, across multiple organizations etc.) to reduce the risk that a sufficient part of the subset of nodes could be compromised.

As noted, the described technologies can be implemented to initiate and/or execute various types of operations. For example, in certain implementations the described technologies can enable secret key extraction. In doing so, the described technologies can enable a stored secret (e.g., a strong cryptographic key or other such sensitive or valuable information or secret) to be retrieved by the client (and used for cryptographic operations). It should be understood that such an implementation can enable a single point (the client) which gains access to such a key and thus should be well protected to avoid exposing the key/secret. In certain implementations, the security of such key/secret can be enhanced if Ts, Tp and the client-side cryptographic operations maintained inside a hardware secure element.

In such a scenario, operation 970 (as described above) can be performed by providing each node's share of the secret (e.g., share 846A from node 820A, share 846B from node 820B, etc., as shown in FIG. 8). As noted, the referenced shares can be created such that the referenced secret is divided based on a cryptographic threshold-encryption scheme. Additionally, this share is the one sent/transmitted to the client machine (e.g., at operation 980).

Additionally, as noted, in certain implementations the described technologies can be implemented to initiate and/or execute operations pertaining to threshold signature(s). For example, the described technologies can be configured to sign data (e.g., a document or its hash) using the referenced secret/strong cryptographic key. For example, the system can be used to sign a piece of data B (e.g., a document, etc.) with the stored secret upon receiving or otherwise determining that a defined threshold of signatures complying with the required signature scheme has been met.

It should be understood that when implementing the described technologies with respect to signing a document, various key request operations (e.g., at operations 920 and/or 950, as described above) can include the referenced document B (and/or its hash or other such representation thereof). Additionally, at operation 970, a threshold signature protocol is executed, and the shares of its output are encrypted by Tp and sent to the client. The client decrypts the shares and constructs the signature signₛ(B).

Thus, such an example process can include operations such as a client sending a document B (or its hash) to each of the nodes, the client receiving a signed document (or its hash) from each node, signed using a key share stored at the respective node, and if the client receives at least enough signed documents from the respective nodes (each signed with a share of the referenced secret/key) to meet/exceed a defined threshold (e.g., at least t (threshold) of n), such signed documents can be combined to generate a signed document (or its hash) without exposing the full key to the client, as described herein.

Additionally, as noted, in certain implementations the described technologies can be implemented to initiate and/or execute operations pertaining to transaction/operation validation. For example, the described technologies can be utilized to enable a transaction or operation in the decentralized network to be approved or executed based on the client's authentication. By way of illustration, the described authentication protocol can be utilized to approve a transaction, e.g., in a manner comparable to a client signature.

It should be understood that when implementing the described technologies with respect to such validation, various request operations (e.g., at operations 920 and/or 950, as described above) can includes the sent transaction to be approved (or its hash or other such representation). Additionally, at operation 970, the threshold signature protocol is or the consensus on the authentication protocol execution directly is used by the nodes to validate the transaction.

In certain implementations, the described authentication protocol performed with respect to a specific transaction can be used as an alternative to the client's signature on a transaction.

Additionally, as noted above, the system may be extended with various additional resulting operations making use of the secret shares and the ability to perform specific resulting operations based on distributed consensus between the nodes. For example, the described technologies can be configured to provide access control for the decentralized system, e.g., in a manner in which the described authentication is used by the node network itself.

Thus, the described technologies provide a framework in which multiple nodes can be configured to operate in cooperation (e.g., based on the described key shares), while preventing any of the specific nodes from having the actual secret (strong key) in its possession.

Additionally, in certain implementations the described technologies can be configured such that the cryptographic key is not known to any of the nodes within the decentralized authentication network, as described herein.

Additionally, in certain implementations the described technologies can be configured such that the authentication protocol includes a smart contract, as described herein.

Additionally, in certain implementations the described technologies can be configured such that the authentication protocol comprises the first challenge, one or more other challenges, and one or more parameters that define aspects of the utilization of the first challenge and the one or more other challenges, as described herein.

Additionally, in certain implementations the described technologies can be configured such that the authenticated operation comprises signing an access token that provides the user identifier with access to the system, as described herein.

Additionally, in certain implementations the described technologies can be configured such that one or more attempts to authenticate via the decentralized authentication network are recorded on a blockchain, DLT, etc., as described herein.

Additionally, in certain implementations the described technologies can be configured such that the processing device, node, etc. cannot access or reveal the cryptographic key, as described herein.

Additionally, in certain implementations the described technologies can be configured such that the authenticated operation comprises signing an access token with the share of the cryptographic key stored at the first node and associated with the network, as described herein.

Additionally, in certain implementations the described technologies can be configured such that user authentication is conditioned on a multi-party consensus that reflects that the user has proven its identity, as described herein.

Additionally, in certain implementations the described technologies can be configured such that one or more aspects of the authentication protocol are determined according to the state of the execution of the authentication protocol, by the first node and one or more other nodes within the decentralized network, as described herein.

Additionally, in certain implementations the described technologies can be configured such that an incentive model configured to incentivize the nodes of the decentralized network to participate, not to collude and to reveal attempts for collusion, as described herein.

Additionally, in certain implementations the described technologies can be configured such that the authentication operation can be completed with respect to a subset of the within the decentralized network, as described herein.

It can therefore be appreciated that the described technologies are directed to and address specific technical challenges and longstanding deficiencies in multiple technical areas, including but not limited to decentralized processing, cryptographic key management, and data processing. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

The various methods disclosed herein may be performed by processing logic that can comprise hardware (circuitry, dedicated logic, etc.), software (such as is run on a computing device such as those described herein), or a combination of both. In one implementation, such method(s) are performed by one or more elements depicted and/or described herein, while in some other implementations, various operations can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

While many of the examples described herein are illustrated with respect to single server and/or individual devices, this is simply for the sake of clarity and brevity. However, it should be understood that the described technologies can also be implemented (in any number of configurations) across multiple devices and/or other machines/services.

It should also be noted that while the technologies described herein are illustrated primarily with respect to decentralized application platform and private key management, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suitable combination thereof. For example, a hardware module can include dedicated circuitry or logic that is permanently configured to perform certain operations. For example, a hardware module can be a special-purpose processor, such as a Field-Programmable Gate Array (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described in conjunction with FIGS. 1-9 are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 10 is a block diagram illustrating components of a machine 1000, according to some example implementations, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein can be executed. The instructions 1016 transform the general, non-programmed machine into a particular machine programmed to carry out the described and illustrated functions in the manner described. In alternative implementations, the machine 1000 operates as a standalone device or can be coupled (e.g., networked) to other machines. In a networked deployment, the machine 1000 can operate in the capacity of a server machine or a client machine in a server-client network environment, or as a peer machine in a peer-to-peer (or distributed) network environment. The machine 1000 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, an integrated circuit card (e.g., a “smart card”), a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 can include processors 1010, memory/storage 1030, and I/O components 1050, which can be configured to communicate with each other such as via a bus 1002. In an example implementation, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 1012 and a processor 1014 that can execute the instructions 1016. The term “processor” is intended to include multi-core processors that can comprise two or more independent processors (sometimes referred to as “cores”) that can execute instructions contemporaneously. Although FIG. 10 shows multiple processors 1010, the machine 1000 can include a single processor with a single core, a single processor with multiple cores (e.g., a multi-core processor), multiple processors with a single core, multiple processors with multiples cores, or any combination thereof.

The memory/storage 1030 can include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 can also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions (e.g., instructions 1016) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), a physical embodiment or impression of machine-readable content (e.g., a barcode/QR code), and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine (e.g., processors 1010), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 can include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 can include many other components that are not shown in FIG. 10. The I/O components 1050 are grouped according to functionality merely for simplifying the following discussion and the grouping is in no way limiting. In various example implementations, the I/O components 1050 can include output components 1052 and input components 1054. The output components 1052 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example implementations, the I/O components 1050 can include biometric components 1056, motion components 1058, environmental components 1060, or position components 1062, among a wide array of other components. For example, the biometric components 1056 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 can include acceleration sensor components (e.g., accelerometer), gravitation sensor components, rotation sensor components (e.g., gyroscope), and so forth. The environmental components 1060 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 1062 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/O components 1050 can include communication components 1064 operable to couple the machine 1000 to a network 1080 or devices 1070 via a coupling 1082 and a coupling 1072, respectively. For example, the communication components 1064 can include a network interface component or other suitable device to interface with the network 1080. In further examples, the communication components 1064 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 can be another machine or any of a wide variety of peripheral devices (e.g., a peripheral device coupled via a USB).

Moreover, the communication components 1064 can detect identifiers or include components operable to detect identifiers. For example, the communication components 1064 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 1064, such as location via Internet Protocol (IP) geolocation, location via Wi-Fi® signal triangulation, location via detecting an NFC beacon signal that can indicate a particular location, and so forth.

In various example implementations, one or more portions of the network 1080 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 can include a wireless or cellular network and the coupling 1082 can be a Code Division Multiple Access (CDMA) connection, a Global System for Mobile communications (GSM) connection, or another type of cellular or wireless coupling. In this example, the coupling 1082 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 can be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 can be transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform one or more operations comprising:
receiving, within a first node of a decentralized authentication network, an authentication request associated with a user identifier;
generating, in accordance with an authentication protocol associated with the user identifier, a first authentication challenge;
receiving, in response to the first authentication challenge, a proof of possession of a first authentication credential;
verifying that the received proof conforms to the authentication protocol; and
based on a verification that that the received proof conforms to the authentication protocol, initiating an authenticated operation with respect to a share of a cryptographic key stored at the first node and associated with the user identifier;
wherein the authenticated operation is completed in conjunction with one or more other shares of the cryptographic key that satisfy a defined cryptographic threshold.

2. The system of claim 1, wherein the authentication request comprises a document to be signed with the cryptographic key.

3. The system of claim 1, wherein the authentication request comprises a transaction to be signed with the cryptographic key.

4. The system of claim 1, wherein the authentication request comprises a request for the cryptographic key.

5. The system of claim 1, wherein the first authentication challenge comprises a request to authenticate using one or more weak keys.

6. The system of claim 1, wherein receiving a proof of possession of a first authentication credential comprises receiving a zero-knowledge proof of the possession of the first authentication credential.

7. The system of claim 1, wherein the memory further stores instructions to cause the system to perform operations comprising receiving, from the client, a public session key.

8. The system of claim 7, wherein transmitting an encrypted output comprises transmitting an output encrypted with the public session key to the client.

9. The system of claim 1, wherein the one or more other shares of the cryptographic key are stored at one or more other nodes of the decentralized authentication network.

10. The system of claim 1, wherein the authenticated operation comprises signing a document with the share of the cryptographic key stored at the first node and associated with the user identifier.

11. The system of claim 1, wherein the authenticated operation comprises signing a transaction with the share of the cryptographic key stored at the first node and associated with the user identifier.

12. The system of claim 1, wherein the memory further stores instructions to cause the system to perform operations comprising transmitting an encrypted output to the client.

13. The system of claim 1, wherein the cryptographic key is not known to any of the nodes within the decentralized authentication network.

14. The system of claim 1, wherein the authentication protocol comprises a smart contract.

14. The system of claim 1, wherein the authentication protocol comprises the first challenge, one or more other challenges, and one or more parameters that define aspects of the utilization of the first challenge and the one or more other challenges.

15. The system of claim 1, wherein the authenticated operation comprises signing an access token that provides the user identifier with access to the system.

16. The system of claim 1, further comprising recording, on a blockchain, one or more attempts to authenticate via the decentralized authentication network.

17. The system of claim 1, wherein the processing device cannot access or reveal the cryptographic key.

18. The system of claim 1, wherein the authenticated operation comprises signing an access token with the share of the cryptographic key stored at the first node and associated with the network.

19. The system of claim 1 where user authentication is conditioned on a multi-party consensus that reflects that the user has proven its identity.

20. The system of claim 1, wherein one or more aspects of the authentication protocol are determined according to the state of the execution of the authentication protocol, by the first node and one or more other nodes within the decentralized network.

21. The system of claim 1, further comprising an incentive model configured to incentivize the nodes of the decentralized network to participate, not to collude and to reveal attempts for collusion.

22. The system of claim 1, wherein the authentication operation can be completed with respect to a subset of the within the decentralized network.

23. A non-transitory computer readable medium having instructions stored thereon that, when executed by a processing device, cause the processing device to perform operations comprising:
generating, with respect to a user identifier, a public session key and a private session key;
transmitting an authentication request associated with the user identifier to one or more nodes within a decentralized authentication network;
receiving a prompt for a first authentication challenge generated in accordance with an authentication protocol;
generating a proof of a possession of a first authentication credential;
broadcasting the generated proof and authentication request to at least one of the one or more nodes within the decentralized authentication network;
based on a verification that the generated proof conforms to the authentication protocol, receiving one or more shares of a cryptographic key associated with the user identifier, each of the one or more shares being stored at one of the one or more nodes of the decentralized authentication network; and
based on a determination that the one or more shares meet a defined cryptographic threshold, initiating one or more cryptographic operations with respect to the cryptographic key.

24. The non-transitory computer readable medium of claim 23, wherein the authentication request comprises a document to be signed with the cryptographic key.

25. The non-transitory computer readable medium of claim 23, wherein the authentication request comprises a transaction to be signed with the cryptographic key.

26. The non-transitory computer readable medium of claim 23, wherein the authentication request comprises a request for the cryptographic key.

27. The non-transitory computer readable medium of claim 23, wherein generating a proof of a possession of a first authentication credential comprises generating a zero-knowledge proof of a possession of a first authentication credential.

28. The non-transitory computer readable medium of claim 23, further comprising receiving, from at least one of the one or more nodes, an encrypted output.

29. The non-transitory computer readable medium of claim 18, wherein the output is encrypted using the public session key.

30. The non-transitory computer readable medium of claim 23, further comprising decrypting the one or more shares with the private session key.

31. The non-transitory computer readable medium of claim 23, wherein initiating one or more cryptographic operations comprises generating, based on the one or more shares, the cryptographic key.

32. The non-transitory computer readable medium of claim 23, wherein initiating one or more cryptographic operations comprises generating, based on the one or more shares, a document signed with the cryptographic key.

33. The non-transitory computer readable medium of claim 23, wherein initiating one or more cryptographic operations comprises, based on the one or more shares, signing a transaction with the cryptographic key.

34. A method comprising:
transmitting an authentication request associated with a user identifier to one or more nodes within a decentralized authentication network;
receiving a prompt for a first authentication challenge generated in accordance with an authentication protocol;
generating a proof of a possession of a first authentication credential;
broadcasting the generated proof and the authentication request to at least one of the one or more nodes within the decentralized authentication network;
based on a verification that the generated proof conforms to the authentication protocol, receiving one or more shares of a cryptographic key associated with the user identifier, each of the one or more shares being stored at one of the one or more nodes of the decentralized authentication network;
based on a determination that the one or more shares meet a defined cryptographic threshold, initiating one or more cryptographic operations with respect to the cryptographic key.

35. A system comprising:
a processing device; and
a memory coupled to the processing device and storing instructions that, when executed by the processing device, cause the system to perform one or more operations comprising:
receiving, within a first node of a decentralized authentication network, an authentication request associated with a user identifier;
generating, in accordance with an authentication protocol associated with the user identifier, a first authentication challenge;
receiving, in response to the first authentication challenge, a proof of possession of a first authentication credential;
verifying that the received proof conforms to the authentication protocol; and
based on a verification that that the received proof conforms to the authentication protocol, initiating an authenticated operation with respect to a share of a cryptographic key stored at the first node and one or more shares of the cryptographic key received from one or more other nodes of the decentralized network that satisfy a defined cryptographic threshold, and wherein the cryptographic key is not known to any of the nodes within the decentralized authentication network.

36. The system of claim 35, initiating an authenticated operation comprises generating an access token with respect to the user.
